(19) United States
(12) Patent Application Publication
(10) Pub. No.: US 2008/0221945 A1
(43) Pub. Date: Sep. 11, 2008

(54) ECOSYSTEM ALLOWING COMPLIANCE WITH PRESCRIBED REQUIREMENTS OR OBJECTIVES

(76) Inventors: Robert Pace, Greenwich, CT (US); Gregg Weinstein, New York, NY (US); Paul Vigilante, Massapequa, NY (US); Richard Cohn, Mamaroneck, NY (US); Walter Joseph Clayton, New York, NY (US); Michael Donahue, Fairfield, CT (US); Claudia Idann Rericha, Crete, IL (US); Mindy Gordon, Bellmore, NY (US)

Correspondence Address: DUANE MORRIS LLP, PO BOX 5203, PRINCETON, NJ, 08543-5203, US

(21) Appl. No.: 11/927,189

(22) Filed: Oct. 29, 2007

Related U.S. Application Data
(60) Provisional application No. 60/938,225, filed on May 16, 2007.
(60) Provisional application No. 60/938,229, filed on May 16, 2007.

(51) Int. Cl. G06Q 40/00; G06Q 99/00

(52) U.S. Cl. 705/7

(57) ABSTRACT

Systems and methods are provided for creating and maintaining an ecosystem, such as for trading securities. For example, in one system, at least one eligibility prerequisite is identified—governing whether an entity is eligible to participate in the ecosystem—and whether the entity meets the eligibility prerequisite(s) is determined. In addition, at least one ecosystem rule is identified, governing whether an entity is qualified to participate in the ecosystem. An eligible entity may execute a contract in which the entity agrees to adhere to the ecosystem rule(s), thus allowing the entity to participate in the ecosystem. The entity may then enter into at least one designated ecosystem transaction, such as buying a security. Participants in the ecosystem may include issuers of securities, investors, brokers, dealers, and research analysts. In this example, the ecosystem seeks to maximize liquidity and transparency while minimizing regulatory obligations.

### CROSS-REFERENCE TO RELATED APPLICATIONS

This United States non-provisional application claims the benefit of U.S. provisional patent applications No. 60/938,225 filed May 16, 2007, and No. 60/938,229 filed May 16, 2007, the entirety of which applications are incorporated by reference in this application.

### FIELD OF THE INVENTION

The present invention relates to systems and methods for establishing and operating a controlled ecosystem. More specifically, the invention relates to creating and maintaining a financial ecosystem whose participants carry on their activities in a manner that ensures compliance with various internal and external qualifications, requirements, and conditions.

### BACKGROUND OF THE INVENTION

Trade in anything that can be bought or sold typically takes place in a market or marketplace. Securities such as stocks, bonds, and options are often traded in a marketplace that has wide participation and is regulated. For the purchase, sale, or resale of securities and other products, a regulated marketplace generally benefits buyers, sellers, and other market participants. But regulated marketplaces can have drawbacks. In some instances, regulation can hinder generally the free flow of information and commerce, and more specifically the formation of capital.

In the United States, an entity that offers its securities to the public generally becomes subject to, among other regulations, (a) registration requirements under United States Securities Act of 1933 (the “Securities Act”), (b) ongoing reporting, proxy solicitation, and other obligations under the United States Securities and Exchange Act of 1934 (the “Exchange Act”), and (c) regulations under the Sarbanes-Oxley Act of 2002 (“SOX”). Complying with the obligations that these regulations impose entails significant time and expense, as well as the risk of significant liability, for the entity issuing securities as well as its officers and directors. Compliance also requires disclosing publicly significant financial and business information, and following certain often-costly processes. Entities that issue securities or other parties who violate these laws and regulations, or that are merely accused of a violation, can face serious regulatory and reputational consequences. Therefore, an issuer that conducts a non-public offering generally does not become subject to the ongoing Exchange Act obligations (including SOX) and the related potential liability for any violations. An issuer that conducts a non-public offering is thus in a substantially different position than an issuer that conducts a registered public offering.

The United States Congress and the Securities and Exchange Commission (the “SEC”) have established laws and regulations that govern whether a particular issuer or other party is subject to the registration and ongoing reporting obligations of the Securities Act and the Exchange Act. Issuers are not subject to these obligations if (a) they offer securities only in “private placements” as defined in the Securities Act, and (b) they remain “private” companies as provided in the Exchange Act. A number of laws and regulations also provide exceptions from the requirements of the Securities Act and the Exchange Act for offerings of securities that meet certain criteria, including the manner of offering and the nature of the offerees.

In addition to the adverse consequences of actual or alleged violations, these regulations have significant effects on the trading market. For example, the offer and sale of securities (in a primary market) on a private-placement basis to certain classes of persons necessitates that these securities cannot be resold (in a secondary market) except in very limited circumstances. Rule 144A under the Securities Act (“Rule 144A”) provides that a private placement will comply with the private placement requirements of the Securities Act—even if the securities are resold freely in the secondary market to and among certain classes of investors—if certain criteria are satisfied. One of the criteria is that all secondary sales are made to persons who the sellers reasonably believe are large institutional investors known as “Qualified Institutional Buyers” (as defined in the rule) or “QIBs”. In this way, Rule 144A allows the issuer to privately place securities to investors that are QIBs, with the prospect of a robust secondary trading market among QIBs. (For example, an issuer may effectively conduct an offering to the QIB market by selling securities in private placements to investment banks, who then resell to QIBs in compliance with Rule 144A.)

The philosophy behind Rule 144A—particularly permitting free-trading in the secondary market among QIBs without requiring Securities Act registration—is that QIBs, by their nature, do not need the same securities-laws protections that are provided when securities are distributed to the general public. Thus, if an issuer limits secondary trading to QIBs (and other limited trading), it can both conduct a private placement and have robust secondary trading without registering the offering under the Securities Act.

But even if an initial private placement and secondary trading are limited to QIBs (and other conduct consistent with the private placement rules) there are still some situations where the reporting and other obligations of the Exchange Act will apply to non-public offerings. Under Section 12(g) of the Exchange Act, for example, even if an issuer has offered its securities only on a private basis (e.g., it has never conducted a public offering that would require registration under the Exchange Act), the issuer will nevertheless be subject to the Exchange Act reporting and other requirements if, among other things, it has a class of equity securities held of record by 500 or more persons. This creates a risk for issuers: if an issuer conducts a non-public offering of securities without a mechanism for controlling the number of holders of record, resales of the securities could result in the securities being held of record by 500 or more persons, thus subjecting the issuer to ongoing Exchange Act obligations. Under these circumstances, if an issuer desires to remain exempt from certain requirements of the Exchange Act, settlement of trades in privately placed equity securities are typically done through issuer-created certificates, resulting in a complicated and time-consuming process that may reduce liquidity.

Therefore, there is a need for systems and methods that allow market participants to interact in a manner that ensures compliance with terms and conditions, including those driven by regulatory constraints. Such restraints may include, for example, (a) a distribution that complies with the private placement requirements of the Securities Act, (b) secondary trading that is limited to trading among QIBs and certain other trading and (c) a settlement system that ensures that there are fewer than 500 holders of record. Thus, one such system or method would permit the sale and trading of securities in a manner that complies with the private-placement exceptions of the Securities Act, limits secondary trading appropriately, and controls for the number of holders of record so that the issuer may remain a “private company” under the Exchange Act.

### SUMMARY OF THE INVENTION

In one embodiment of the invention, an apparatus is provided. The apparatus includes:
a processor;
a storage device in communication with the processor;
means for determining whether an entity meets at least one eligibility prerequisite for an ecosystem, thereby being eligible to participate in the ecosystem;
means for determining whether an entity is willing to agree to at least one ecosystem rule, thereby being qualified to participate in the ecosystem;
means for processing data regarding executing a contract in which the entity agrees to adhere to the at least one ecosystem rule, thereby allowing the entity to participate in the ecosystem; and
means for processing data regarding entering into at least one designated ecosystem transaction by the entity.

In another embodiment, the apparatus also includes:
means for determining whether the entity agrees to adhere to at least one designation prerequisite and is within a limitation criterion; and
means for processing data regarding granting the entity designated status, thereby permitting the entity to engage in the at least one designated ecosystem transaction.

In yet another embodiment, in the apparatus the designation prerequisite includes one or more issuer-specific criteria and the limitation criterion is a number of holders of record.

In yet another embodiment, in the apparatus the number of holders of record is less than 500.

In yet another embodiment, another apparatus is provided. The apparatus includes:
a processor;
a storage device in communication with the processor and storing instructions adapted to be executed by the processor to:
   identify at least one eligibility prerequisite that governs whether an entity is eligible to participate in an ecosystem;
   determine whether the entity meets the at least one eligibility prerequisite, thereby being eligible to participate in the ecosystem;
   identify at least one ecosystem rule that governs whether an entity is qualified to participate in the ecosystem;
   determine whether the entity is willing to agree to the at least one ecosystem rule, thereby being qualified to participate in the ecosystem; when the entity is eligible and qualified, process data regarding executing a contract in which the entity agrees to adhere to the at least one ecosystem rule, thereby allowing the entity to participate in the ecosystem; and
   process data regarding entering into at least one designated ecosystem transaction by the entity.

In yet another embodiment, a computer-implemented method for establishing and operating an ecosystem is provided. The method includes:
identifying at least one eligibility prerequisite that governs whether an entity is eligible to participate in the ecosystem;
determining whether the entity meets the eligibility prerequisite(s), thus becoming eligible to participate in the ecosystem;
identifying at least one ecosystem rule that governs whether an entity is qualified to participate in the ecosystem;
determining whether the entity is willing to agree to the ecosystem rule(s), thus becoming qualified to participate in the ecosystem;
when the entity is eligible and qualified, executing a contract in which the entity agrees to adhere to the ecosystem rule(s), thus allowing the entity to participate in the ecosystem; and
entering into at least one designated ecosystem transaction by the entity.

In yet another embodiment, one eligibility prerequisite is status as a Qualified Institutional Buyer.

In yet another embodiment, one ecosystem rule is prohibiting short selling.

In yet another embodiment, the method also includes:
identifying at least one designation prerequisite and a limitation criterion that govern whether the entity is permitted to engage in the one designated ecosystem transaction(s);
determining whether the entity meets the designation prerequisite(s) and the limitation criterion, thus becoming to engage in the one designated ecosystem transaction; and
when the entity is so permitted, granting the entity designated status, thus allowing the entity to engage in the designated ecosystem transaction(s).

In yet another embodiment, the designation prerequisites are one or more issuer-specific criteria and the limitation criterion is a number of holders of record.

In yet another embodiment, the number of holders of record is less than 500.

In yet another embodiment, another computer-implemented method for establishing and operating an ecosystem is provided. The method includes:
identifying at least one first prerequisite that governs whether an entity is eligible to participate in the ecosystem;
determining whether the entity meets the first prerequisite(s), thus becoming eligible to participate in the ecosystem;
identifying at least one second prerequisite that governs whether an entity is qualified to participate in the ecosystem;
determining whether the entity meets the second prerequisite(s), thus becoming qualified to participate in the ecosystem;
when the entity is eligible and qualified, executing a contract in which the entity agrees to adhere to the second prerequisite(s), thus allowing the entity to participate in the ecosystem;
identifying at least one third prerequisite that governs whether the entity is permitted to engage in one or more designated ecosystem transactions;
determining whether the entity meets the third prerequisite(s), thus permitting the entity to engage in the designated ecosystem transaction(s);
when the entity is so permitted, granting the entity designated status, thus allowing the entity to engage in designated ecosystem transaction(s); and
entering into one or more designated ecosystem transactions by the entity.

In yet another embodiment, the first prerequisite is an investor status.

In yet another embodiment, the investor status is Qualified Institutional Buyer.

In yet another embodiment, the second prerequisite includes ecosystem rules.

In yet another embodiment, the ecosystem rules include prohibiting short selling.

In yet another embodiment, the third prerequisite includes at least one issuer-specific criterion.

In yet another embodiment, the issuer-specific criteria includes prohibiting short selling.

In yet another embodiment, the third prerequisite also includes at least one limitation criterion.

In yet another embodiment, limitation criteria includes a number of holders of record.

In yet another embodiment, the number of holders of record is less than 500.

In yet another embodiment, another computer-implemented method for establishing and operating an ecosystem is provided. The method includes:
processing data regarding determining whether an entity meets at least one eligibility prerequisite, thereby being eligible to participate in the ecosystem;
processing data regarding determining whether an entity is willing to agree to at least one ecosystem, thereby being qualified to participate in the ecosystem;
when the entity is eligible and qualified, processing data regarding executing a contract in which the entity agrees to adhere to the at least one ecosystem rule, thereby allowing the entity to participate in the ecosystem; and
processing data regarding entering into at least one designated ecosystem transaction by the entity.

In yet another embodiment, the computer-based method also includes:
processing data regarding determining whether the entity agrees to adhere to at least one designation prerequisite and is within a limitation criterion, thereby permitting the entity to engage in designated ecosystem transactions; and
when the entity is so permitted, processing data regarding granting the entity designated status, thereby allowing the entity to engage in the at least one designated ecosystem transaction.

In yet another embodiment, in the method the designation prerequisites include one or more issuer-specific criteria and the limitation criterion is a number of holders of record.

### BRIEF DESCRIPTION OF THE DRAWINGS

The accompanying drawings illustrate several embodiments in accordance with the present invention:

FIG. 1 is a schematic representation of an exemplary embodiment of a financial ecosystem in accordance with the invention.

FIGS. 2A and 2B are a schematic representation of a system for the registration and sale of securities to qualified investors through a securities dealer/broker in conformance with an exemplary embodiment of the invention.

FIG. 3 is a flow chart for processing orders through an exemplary embodiment of the invention related to sales of securities under Rule 144A.

FIG. 4 is a flow chart of actions taken by a broker during reservation and processing of orders under Rule 144A.

FIG. 5 is a system administration screen for the system for the financial ecosystem of FIG. 1.

FIG. 6 is a flow chart for an initial offering of securities under Rule 144A.

FIG. 7 is an exemplary screen of the system to allow for association of an internal broker account number with an investor.

FIG. 8 is an exemplary screen of the system to allow listing of book-entry custodians.

FIG. 9 is an exemplary screen of the system to allow listing of broker participants.

FIG. 10 is an exemplary screen of the system to allow the reservations process to be managed for issuers.

FIG. 11 is an exemplary screen of the system to perform a reservation request for a specific security.

FIG. 12 is an exemplary screen of the system to verify a reservation of a specific security.

FIG. 13 is an exemplary screen of the system to verify or request reservation for a specific security.

FIG. 14 is an exemplary screen of the system to verify available investor positions.

FIG. 15 is an exemplary screen of the system to allow the broker to update the investor's QIB status.

FIG. 16 is an exemplary screen of the system to allow the broker to input a new investor.

FIG. 17 is an exemplary screen of the system to allow the broker to review the springing contract and any additional terms and conditions as well as issuer amendments.

FIG. 18 is schematic representation of systems interaction for the ecosystem.

FIG. 19 is a block diagram illustrating one embodiment of the present invention in an ecosystem controller.

### DETAILED DESCRIPTION OF PREFERRED EMBODIMENTS

In one embodiment, the present invention provides an environment—which we refer to as an “ecosystem” or “financial ecosystem”—that allows only certain participants to privately place trade orders, trade securities, settle trades, and receive non-public information. A financial ecosystem may include, without limitation, one or more of issuers of securities, investors, brokers, dealers, securities custodians, transfer agents, research analysts, and other market participants. An ecosystem according to this embodiment also establishes participant-qualification standards.

In this embodiment, an entity (other than an issuer or service provider) must first be a Qualified Institutional Buyer (“QIB”) to be eligible to participate in the ecosystem. If an entity successfully establishes this status, to qualify to participate in the ecosystem the QIB is required to sign a springing agreement that specifies additional screening criteria. QIBs that have signed the springing agreement obtain the status of “recognized QIBs” and may participate in the ecosystem. For example, recognized QIBs are given access to specified non-public information, including information relating to companies that have issued securities that are expected to trade in the ecosystem. In other embodiments, other types of buyers than QIBs may become qualified and are contemplated and understood to work in the ecosystem.

To purchase a security issued by a particular company that is traded in this embodiment of the ecosystem, a recognized QIB must further qualify as a “designated investor,” which has two prerequisites. First, a recognized QIB must agree to any additional terms specific to the issuer of the securities to be purchased (thus amending the springing agreement accordingly, and causing the issuer to have privity of contract with the issuer). Second, the ecosystem must grant the recognized QIB a reservation number or “slot” to purchase the securities, but a slot is granted only if specified criteria are met (e.g., there are less than a certain number of existing shareholders). If the ecosystem determines that these two prerequisites are met, the recognized QIB qualifies as a designated investor. In other embodiments, the issuer may specify additional prerequisites for a recognized QIB to obtain designated investor status.

In various embodiments, QIB-related information may be recognized by the ecosystem through data entry into an ecosystem database. As such, the ecosystem may read in QIB-related information from an investment table, client table, or otherwise through an ecosystem database record, and such information may then be used by the ecosystem to perform a comparison to the prerequisites to establish qualification. The agreement terms or the entire agreement may be stored in an ecosystem client table or other ecosystem database record. A recognized QIB's qualification status or the status of each prerequisite may be stored in the ecosystem database (e.g., as BOOL value set to “TRUE”).

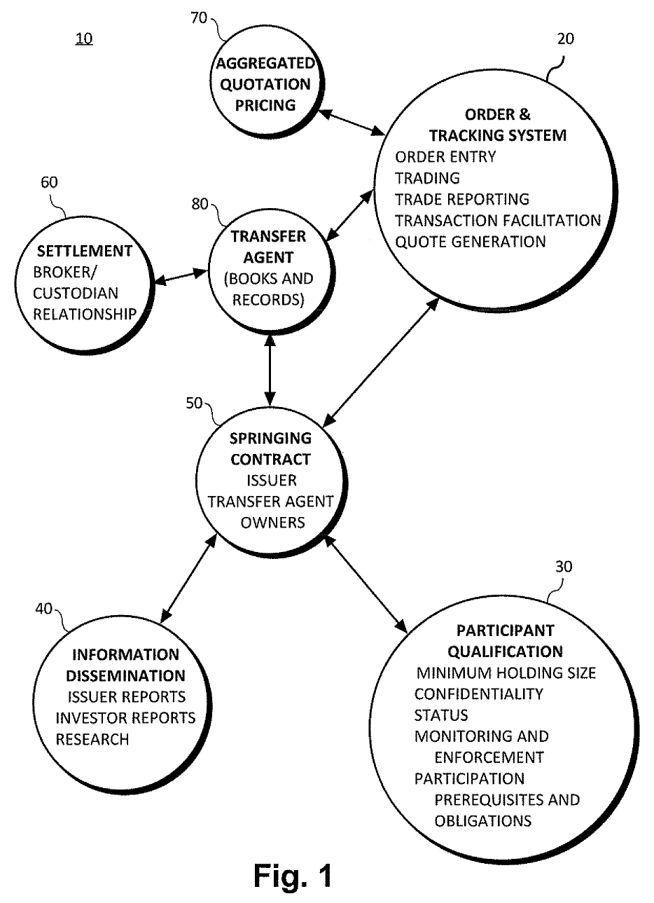

FIG. 1 schematically represents a financial ecosystem 10 formed in accordance with one embodiment of the present invention, which is suitable for trading securities. But it should be understood that the present invention is not limited in scope to trading securities. In other embodiments the invention may be used to form an ecosystem suitable for exchanging a wide variety of services, products, commodities, rights, and obligations without deviating from either the breadth or spirit of the invention. To give just one example, an ecosystem formed according to the invention may be used to exchange emissions in a “cap and trade” program.

The financial ecosystem 10 is constituted by specific sub-parts, sub-systems, components, or modules; for the sake of simplicity these will be referred to as various “systems.” First, the financial ecosystem 10 has an order entry and execution system 20 that handles operations concerning order entry, order tracking, trade reporting, transaction facilitation, and quote generation. For example, the order entry and execution system 20 allows for the screening and rejection or acceptance of orders from participants. The order entry and execution system 20 also allows for the reporting and transparency of orders, as well as facilitating market-making and stock lending. The order entry and execution system 20 further allows for stock lending only by designated liquidity providers to provide investors with liquidity. In this embodiment, a designated liquidity provider is a broker/dealer designated by an issuer that facilitates the trading of a security. Multiple designated liquidity providers may act within the ecosystem, if desired. The order entry system and execution system 20 also allows for reporting of transactions, as well as other transaction-facilitation functions.

The financial ecosystem 10 also provides a verification system 30 that allows for QIB status checking and qualification) as well as tracking and enforcement capability. Participation prerequisites, including QIB status, and obligations are checked and maintained among participants by the ecosystem. Similarly, the ecosystem may perform checks on other prerequisites, such as minimum holding amounts, the nature of the investor or its investment (e.g., not for ERISA funds). Additionally, an agreement to maintain confidentiality of certain information may be incorporated in the ecosystem.

The financial ecosystem 10 also provides an information dissemination system 40 that facilitates the generation of reports and tracking of materials published by issuers and other participants. The information dissemination system 40 also provides for confidentiality, within established parameters, including those derived from SEC rules. The reports that may be generated in the information dissemination system 40 may include issuer reports, research reports, and trading statistics, as non-limiting examples.

The financial ecosystem 10 also provides for a springing contract system 50 that establishes privity of contract between certain eligible entities, including QIBs, and a particular issuer before providing the entities with access to trading functions and certain other aspects of the ecosystem with respect to that particular issuer. Certain reports generated from issuer-provided materials in the information dissemination system 40—including significant shareholder reports and trading reports by insiders—are provided to registered QIBs (i.e., QIBs who have agreed to and signed the springing contract). The springing contract system 50 allows for establishment of a screening criterion for all potential participants in the financial ecosystem 10 and separates activities between QIBs generally and recognized QIBs. As a result, the springing contract system 50 establishes baseline criteria for all participants. For example, the springing contract system 50 may provide that, in addition to being a QIB, an investor may not short sell securities or create derivatives in securities, or may sell securities only to a designated list of other recognized QIBs. Once a springing contract is completed by a QIB in the springing contract system 50, the agreement is provided to the securities transfer agent and, before purchasing an issuer's securities, the QIB agrees that it has privity of contract with that particular issuer with respect to the springing contract and any additional terms specified by that particular issuer. The ecosystem may generate reports on a real-time, semi-real-time, or on-demand basis, such as every week, month, or quarter (e.g., via cron job queries and report jobs). Reports may be prepared pertaining to trades and traders' actions. To that end, the report may include a green/yellow/red indicator to provide QIBs and issuers an indication of the number of transaction reservations remaining to be provided within the financial ecosystem 10.

After trades are complete in the order entry and execution system 20, the verification system 30, and the information dissemination subsection 40, settlement of trades is provided in the settlement system 60. The settlement system 60 allows for a normal settlement cycle using a fast physical model or an electronic book-entry model. A securities transfer agent section 80 may allow for completion of electronic orders and for connection to the settlement section 60.

The financial ecosystem 10 is also configured to interact with aggregated quotation pricing system 70, which accesses indexes and data services commonly used in the financial markets and services industry. In one embodiment, the financial ecosystem 10 may interact with Bloomberg financial services and the REDI+ trading system.

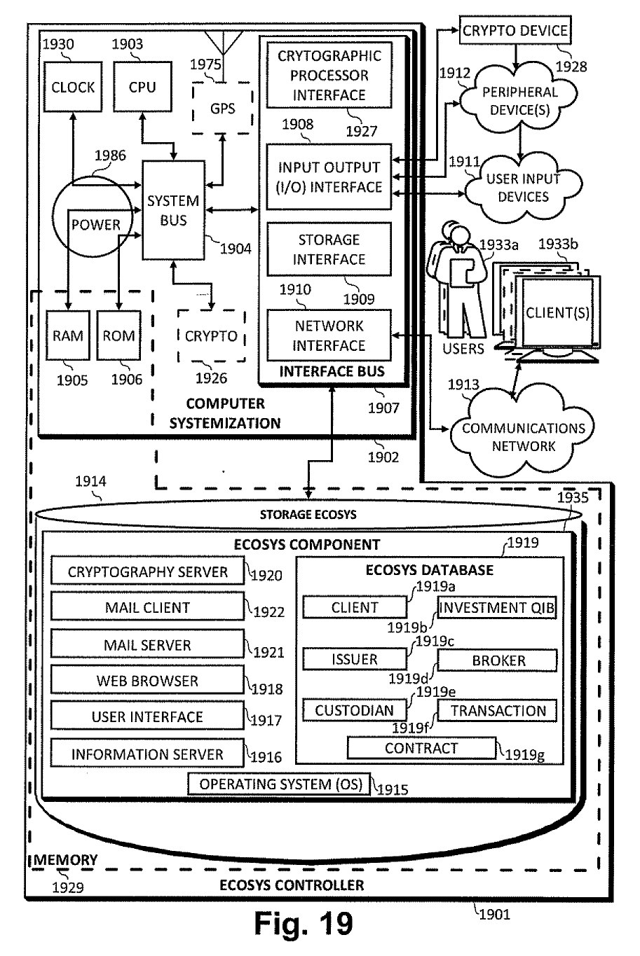

The above-described systems may interoperate or communicate via inter-system or inter-application communication models such as via a transport protocol (e.g., HTTP) for messaging distributed method calls, connectors, or the like techniques as further described in the ecosystem controller of FIG. 19 and throughout the disclosure.

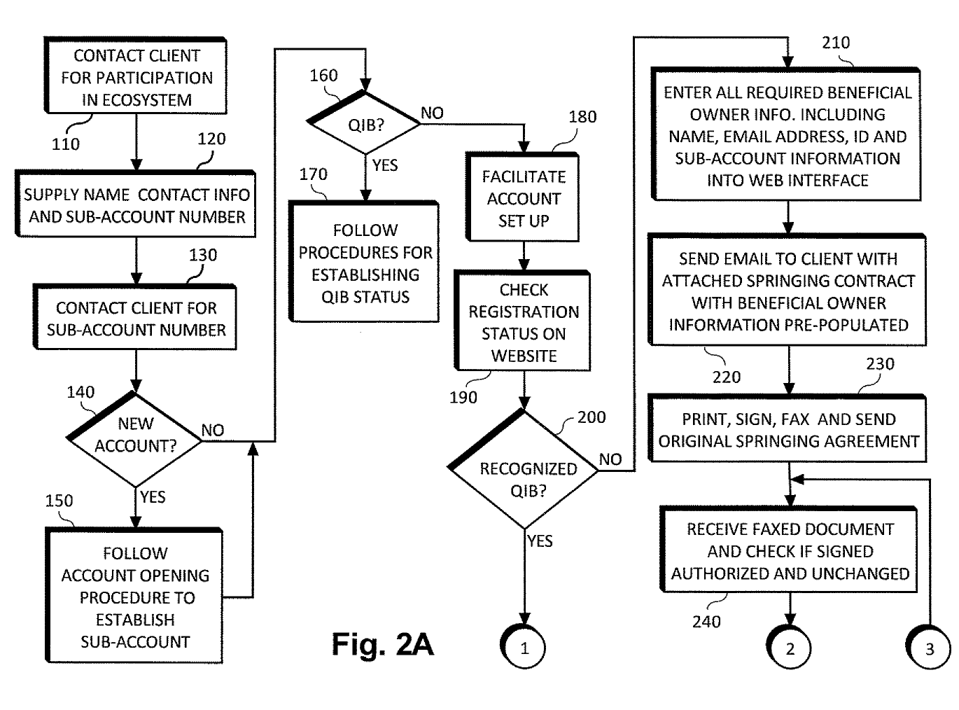

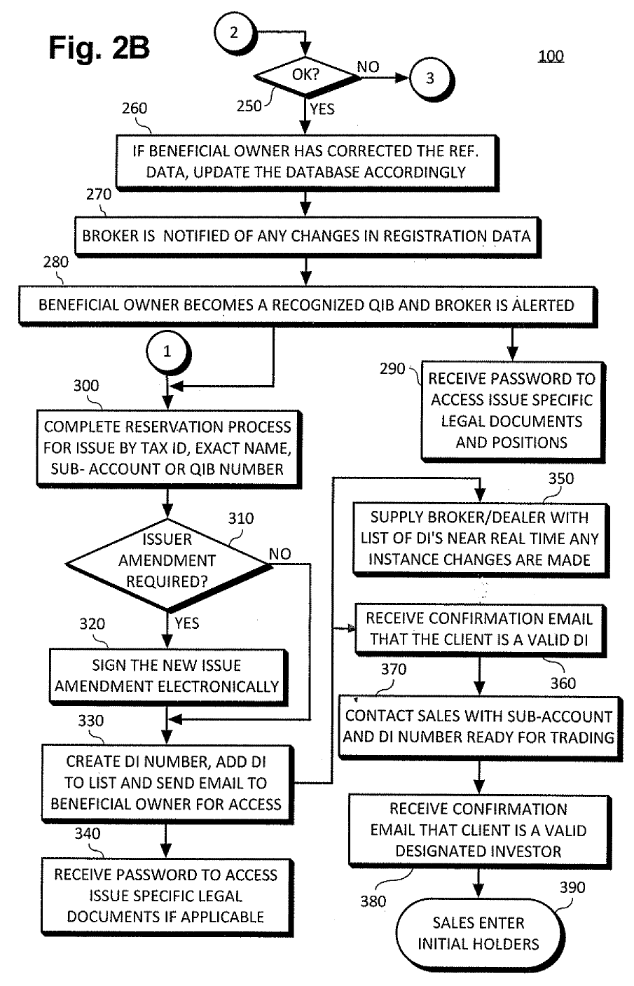

Referring to FIGS. 2A and 2B, in one preferred non-limiting embodiment the financial ecosystem 10 uses a registration system 100 that allows sales of securities to and among QIBs in compliance with United States securities law as overseen by the SEC. Many different securities may be controlled by registration system 100 including but not limited to stocks and bonds. The registration system 100 used to conduct these transactions is created such that only recognized QIBs may participate. For the purposes of this embodiment, a QIB is an institution that satisfies the criteria established by the SEC in Rule 144A (e.g., an entity that manages at least $100 million in securities and has a net worth of $25 million or more). In alternative embodiments, the ecosystem may configured to use other values/qualifications and threshold criteria for establishing QIB status. In this embodiment, a recognized QIB is a QIB that has signed a springing contract and is bound to its terms.

For the registration system 100 as shown in FIG. 2A, a sales trader/broker contacts (or is contacted by) a potential client/investor for participation in the system for the registration and sale of securities at block 110. One example of a client/investor is an investment adviser. In one embodiment, the advisor may authorize the ecosystem to initiate a communication (e.g., e-mail, facsimile, telephone call) from a database of potential client/investors that are stored in the ecosystem database. This initiated communication can be logged by the ecosystem in the ecosystem database, and any notes taken by the advisor may also be logged.

After a client/investor is contacted by a broker (or contacts a sales trader/broker) for participation in the marketplace at block 110, the potential client/investor supplies a name, contact information, and a sub-account number (if known) to a sales trader/broker at block 120. As used in this embodiment, a sub-account number refers to an account that is created for a client for the trading of securities. In this embodiment, the sub-account number may be established by a sales trader/broker trading in securities for the express purpose of identifying QIBs. Using the contact and identification information supplied at block 120, a registration form may be completed by/for the potential client/investor contacted in block 110 by the broker. Alternatively, a secure Web form is provided, allowing the user to fill the form electronically. Reproducible copies are maintained for future production if needed (e.g., by regulatory entities).

Although described above as requiring the potential client/investor to supply the limited data of a name, contact information and sub-account number at block 120, other distinguishing informational data may be requested from the potential client/investor of the securities being sold. This other data can include, for example, Social Security numbers, corporate identification numbers, certificates of incorporation, partnership agreements, and bank financial information. All of the foregoing are not limiting examples, and therefore the information described should not be considered limited.

At block 130, the potential client/investor may submit to the registration system 100 any sub-account information previously obtained, to the broker. Additionally, the client/investor may be contacted to obtain the sub-account information not supplied to the broker. As already discussed, the sub-account information may be, for example, pre-existing information provided by a securities dealer/broker in prior dealings between the securities dealer and the potential client/investor, or on a potential client record maintained in the ecosystem database. The information obtained from the potential client/investor relating to the sub-account of block 130 is then cross-checked with information presently handled or tracked by the securities dealer. In another embodiment, to facilitate validation, an existing-client database table may be queried for existing-account information. The ecosystem then determines, based on the sub-account information, whether or not the potential client/investor has an existing account 140 with the securities dealer. If the information obtained from the potential investor at block 130 indicates that a sub-account exists, the registration system 100 then proceeds to block 160 to determine if the potential client/investor is a QIB, as defined above. If the sub-account information obtained from the client at block 130 shows that a new account is required for the potential investor, a sub-account opening procedure is started where the potential client/investor is required to provide the accurate information to open an account with the securities dealer at block 150. In another embodiment, the investor may be provided with a secure Web form to supply such information to the ecosystem database.

At block 160, the registration system 100 checks the potential client/investor in compliance with current SEC guidelines or other criteria to determine if the potential client/investor is a QIB. In this embodiment related specifically to SEC guidelines, an investor that has a net worth of at least $25 million and at least $100 million of securities under management would be a QIB. The present ecosystem may be modified to establish other qualifications for QIBs.

If the registration system 100 verifies the status of the potential client/investor as a QIB at block 160, the system establishes an account for trading in private securities at block 180. For example, a new account record is instantiated in the client database table. The system then conducts a separate registration check for the account at block 180 such that a verification of the account, as well as an interconnection capability at block 190 between the account and a securities transfer agent, is provided. After successful verification that the potential client/investor is a QIB at block 160, a separate check at block 200 is performed to determine whether the client/investor is a recognized QIB. If the QIB is not a recognized QIB, then the QIB is requested to provide beneficial owner information including an individual or corporate name, an e-mail address, an identification number, and sub-account information as provided at block 210. At block 210, a Web interface is created between the entered beneficial owner information and client account information. If the recognized QIB is an offshore entity, a registrar of companies or a company registration number is required and may be stored in the ecosystem database (e.g., for verification purposes). If the QIB is not a recognized QIB, processing proceeds to block 300 in FIG. 2B (via connector 1).

After the required beneficial owner information is included in the registration system 100, including the name, e-mail address, identification number and sub-account information with corresponding web-interface, an electronic notification is sent via the system to the QIB along with a springing contract at block 220. The springing contract may be pre-populated with the beneficial owner information. The beneficial owner completes the springing contract via the system at block 220, in this case electronically (e.g., by signing a provided click-wrap agreement via Web form, scanning in an executed contract and uploading it via Web browser “Browse” button attachment, etc.), and sending the completed and executed springing contract back to the equity transfer agent as specified at block 230 (e.g., via HTML/XML code returned via HTTP).

In this embodiment, the springing contract is completed by a QIB to identify the rights and responsibilities associated with participating in securities offerings, including trading under Rule 144A. For QIBs, a springing contract is required to be completed via the system at block 220 by the investor before being provided a designated investor number. For recognized QIBs, springing contracts are required to be periodically recertified, e.g., every 16 months, via the system at block 220. Only designated investors with respect to an issuer are permitted to engage in registration and trading of securities under the ecosystem.

In some embodiments of the invention, the ecosystem is configured to limit the number of designated investors with respect to an issuer by setting a maximum number of designated investors below a threshold number of investors that is defined by the issuer and that may be designed to avoid having to become a reporting company under the Exchange Act. These limitations may be stored as individual field entries and/or as an XML entry of QIB terms in the ecosystem database. An example of the XML table follows:

<Investment_ID_guid=“1234567”>

<Investor_name=“JohnSmith28” />
<SubAccount_ID_value=“1112” />
<Broker_ID_value=“123” />
<Terms>

<Min_Investor_Number value=“20” />
<Max_Investor_Number value=“234” />
<Min_Num_Shares_pTrade value=“100” />
<Min_investment_amount value=“100,000” />
<Min_Holding_Size value=“20” />
<Max_Investor_Number value=“234” />

</Terms>

</Investment_ID>

In this embodiment, the springing contract is signed before trading so that the QIB becomes a recognized QIB. The issuer may have additional terms identifying further rights and obligations of the issuer and the designated investor with respect to the issuer's securities. Additional terms for a particular issuer apply only to designated investors for that issuer, i.e., once an investor applies for a slot to purchase the securities of that issuer. For primary issuance of a security, for example, the springing contract and issuer additional terms are sent via the registration system 100 to the client/investor before trading at block 220. The client/investor signs the springing contract and confirms acceptance of the issuer additional terms via the system at block 230 and sends the signed springing contract to the transfer agent. For secondary trading (trading after the primary issuance) the springing contract is sent via the system to the client/investor before trading at block 220. The client/investor signs the springing contract and confirms acceptance of the issuer additional terms via the system at block 230 and sends the original agreement to the transfer agent.

At that point, the investor is a recognized QIB and has the right to access information within the financial ecosystem 10 (including information relating to companies that have issued securities in the ecosystem) and to apply for a slot to purchase securities within the ecosystem, if available. If a recognized QIB wishes to purchase the securities of a particular issuer, it must agree electronically via the registration system 100 through a web interface at block 320 to any issuer-specified additional terms, as indicated at block 310. In some embodiments, at the initial allocation in a primary offering by the issuer, once a QIB entity agrees to the springing contract to become a recognized QIB, the entity signs the springing contract and the additional terms at the same time. Where the QIB has not already signed the springing contract, they can become a recognized QIB and may be provided with a designated investor number/position with respect to that issuer, as provided at block 330.

In another embodiment of the invention, a QIB becomes a recognized QIB when it executes the springing contract. When a recognized QIB wishes to purchase a particular security, it requests a designated investor number and is provided one if the ecosystem determines that a slot is available; this allows the recognized QIB to purchase the securities in exchange for their agreement to be bound by the additional terms for that particular security. In other embodiments, in addition to a slot being available, other prerequisites must be met.

The information entered on the springing contract is processed by the registration system 100 at block 240, and routing of the information received pertaining to springing contract is accomplished at block 250, in FIG. 2B (via connector 2). If the information entered on the springing contract is deficient, a new springing contract is then provided to the QIB for reexecution, at block 230 (via connector 3), in this case electronically. If the authentication of the information placed within the springing contract is completed at blocks 240 and 250, then, at block 260, any information that has been identified by the QIB as needing or requiring to be updated will be entered into an ecosystem database, for example, at the equity transfer agent.

After the registration system 100 updates the database with the corrected information at block 260, brokers are notified of any changes in registration data by the equity transfer agent via the system at block 270. After updating the ecosystem database, the investor becomes a recognized QIB at block 280. Identification of the investor as a recognized QIB is accomplished within the registration system 100 to track the database information. At block 290 the newly recognized QIB—typically an investment manager, designated liquidity provider, or custodian—receives a password to access specific information related to the issuer of securities, such as quarterly reports and annual reports for significant shareholders and trading by insiders. The recognized QIB is then able to complete a reservation process for purchase of particular securities. Completion of the reservation process includes input of information, such as, for example, identification numbers, exact names, sub-accounts, or recognized QIB numbers as provided at block 300. In another embodiment, this information is queried and selected from existing records in the ecosystem database or obtained via Web form. The registration system 100 then determines at block 310 if there are any issuer-specific additional terms that are required. If additional terms are required at block 310, then the client/investor agrees to these additional terms electronically via the system through a web interface at block 320. The recognized QIB is deemed to have accepted and agreed, for the benefit of the issuer, to the issuer-specific additional terms by applying for a designated investor number/position with respect to that issuer.

If issuer-specific additional terms are not required, or if new issuer-specific additional terms are provided at block 320, and there are sufficient slots available for trading, then at block 330 the registration system 100 creates a designated investor number for the recognized QIB. The designated investor number is added to a list of similar designated investor numbers cleared for activity for that issuer (the designated investor list). Electronic information is transferred to the recognized QIB advising that a designated investor number has been created and assigned.

In this embodiment, trades are permitted only for designated investors (i.e., recognized QIBs that have secured slots to purchase securities). If a designated investor does not execute a trade within a time specified by the issuer, the ecosystem nullifies the designated investor number (e.g., the ecosystem revokes the slot by changing the number-of-available-investment-slots entry in the investment table of the ecosystem database or by disassociating the designated investor number with the investment in the ecosystem database), thereby allowing another recognized QIB to have the slot, become a designated investor, and have an opportunity to execute trades in the security. For example, the specified time may be two business days after receipt of the slot. A cron job may be sent to verify that execution occurs by querying the account in two days for executing matching trades. In this embodiment, in order to maintain the standards of the financial ecosystem 10, designated investors trade only with other designated investors in accordance with the terms of the springing contract.

To maintain each designated investor list, securities brokers/dealers of the securities trading in the system trading under Rule 144A are updated by the registration system 100 with current designated inventor lists, for example, by cron job at the beginning of each work day. Additional updates may also be provided on an intra-day interval when changes in designated investor lists have been made. File transfer of the designated investor lists may be accomplished, for example, by file transfer protocol (“FTP”).

Intra-day file generation, which may be transferred via FTP, is initiated in registration system 100 after a purchase, sale, or reservation of securities in the Rule 144A trading system. To preserve issuer confidentiality, the ecosystem may employ various access privileges keyed to broker/securities dealer names/identifiers, thus providing access only to their specific clients' (designated investors') information. The fields provided for each file that are reviewable include a broker or sub-account number (previously supplied by the individual broker/securities dealer), an identification number for each security issued, and a status indicator showing whether the designated investor can buy or sell the securities. The status indicator may take into account required holding periods for Rule 144A securities.

At block 340 the recognized QIB receives via the registration system 100 a password to accept and access information provided for distribution to recognized QIBs and designated investors. Additionally, the ecosystem provides investment brokers and dealers with a list of designated investor numbers for their clients/investors via the system at block 350. At block 360, a confirmation is made of the valid designated investor number created at block 330. Brokers are then contacted via the system, at blocks 370 and 380, with a sub-account and designated investor number such that selling/trading may begin. Purchases and sales are then conducted in accordance with the issuer's terms.

This embodiment allows for the time- and process-efficient registration of participants in the financial ecosystem 10. As investors are pre-qualified for trading in compliance with Rule 144A, the time-consuming and complicated process of receiving separate legal opinions and certificates for individual purchases is unnecessary because the parameters for trading are pre-announced and agreed to by market participants.

Each of the designated investors, for example, may authorize its custodian to settle trades and handle client-specified activities. Custodians have the option to settle trades through the fast physical model or book-entry model. Custodians will be allowed to register in the ecosystem to hold certificates. If a custodian is not registered using an authorized computer system, the certificates being purchased may be listed by the ecosystem as “custodian for the benefit of beneficial owner” and returned to the executing broker for delivery to the custodian. The financial ecosystem 10 in this embodiment tracks equities transfers to and from accounts. Custodians, if qualified and authorized by the system, may also be allowed to download or identify the positions taken by their respective clients. Securities trading is facilitated by a broker who may be the designated liquidity provider posting the bid and ask prices for the equities to be traded. Stock certificates may be relinquished by a designated investor or the custodian upon selling/trading of the securities and transferred to the new purchasing account once the purchase has been settled through the equity transfer company. Custodians may also be allowed to review accounts for customers after reconciliation occurs. In one embodiment, the ecosystem may verify such Custodian interactions and provide such verifications by retrieving investment terms from the ecosystem database and using those terms to query investor/Custodian record entries to find matches for compliance.

In this embodiment, the issuer of the securities is responsible for several selling conditions. For example, the issuer is responsible for setting the size of the designated investor list. This may be done by providing a list-size entry to the investment table of the ecosystem database. In one embodiment, in compliance with Section 12(g) of the Exchange Act, the designated investor list must have fewer than 500 holders of record. But in other embodiments, based upon the needs of the issuer of the securities and the ecosystem generally, the maximum number of investors may be significantly less than 500. The securities issuer also selects the size of the total issue of securities placed in the market. In general, the issuer will select a total amount of the capital that is required to be raised by the issuance of the securities and select the number and value of the securities accordingly. The term of the security may also be chosen. For example, if the security is a bond or note, pay-off values/conditions such as time and interest rate may be specified.

The issuer may also be involved in the approval process for designated investors. Issuers, for example, may not wish to have certain types of recognized QIBs participating in the placement of securities (e.g., competitors, off-shore entities). An issuer may, via the ecosystem, instruct establishing a minimum amount of money to be invested (position) for each designated investor, for example that the investment by each designated investor is kept above a minimum value (in other words, designated investors establishing a relatively minor investment may be excluded). The issuer may also be involved in setting a minimum number of positions for investment by the designated investors or a maximum number of slots per designated investor. Recognized QIBs may have the capability to make their own respective reservations for purchases, and also be allowed to review a list of approved brokers for conducting transactions.

Similarly, qualification of a minimum number of shares per trade for designated investors may be established, if applicable, by the issuer. Designated liquidity providers will not accept orders unless the minimum lot size is met in these instances. The issuer may also impose a minimum holding size for each designated investor. Similarly, the ecosystem allows issuers to impose a time limit for a designated investor to reach the minimum holding size by specifying and storing the limit in the investment table of the ecosystem database. For example, the default time limit may be ten business days. The issuer may also institute limits on ownership of the securities. The financial ecosystem may be monitored, such as by transfer agents or issuers. Issuers may include restrictions on securities trading, if desired. Typical restrictions may be related to numerous requirements by regulatory bodies such as foreign entity status, ERISA requirements, or Federal Communications Commission requirements, as non-limiting embodiments. Issuers may also set parameters such that designated investors are removed from the designated investor list when the designated investors do not purchase securities (over a specified time frame) or do not fulfill the minimum position required. The issuer may also limit the total number of designated investors. In one embodiment, a Web form is provided to issuers to enter any and all such limitations, which in turn may be saved in the ecosystem (e.g., in an investment table), and used by the ecosystem to ensure that issuer-specific criteria are honored. All such limits, restrictions, requirements, verifications, parameters, etc. may be set or specified in the ecosystem database.

Issuers may also supply information, such as legal documentation, to the registration system 100 created to track sales of the securities. Such information from the issuer may be provided to the ecosystem as one way to comply with a variety of SEC rules. Moreover, other company-specific materials may be displayed on the computer arrangement (e.g., an ecosystem controller), such as quarterly or annual reporting materials, as well as other research information. In one embodiment, the computer arrangement is configured with password protection to restrict information distribution only to individuals with proper access credentials. Issuers may also administer culling procedures for designated investors if the designated investor list reaches a maximum size. If the number of designated investors expands to a value approaching the maximum number, issuers may specifically require liquidation of securities-related assets for individual designated investors. The springing contract may also allow for ecosystem management, including removing participants such as holders of securities. For example, the springing contract (or issuer-specific additional terms) may require the liquidation of securities held by a designated investor if the minimum number of shares to be held by a designated investor is not satisfied. In such a case, the ecosystem may send a notice of the required liquidation along with a request for authorization (e.g., via an e-mail with a Web link to a click-wrap agreement so authorizing), provide shares for liquidation to a trading system, or the like when the ecosystem determines that number of shares by the designated investor is insufficient (e.g., by retrieving the investment-table minimum-number-of-shares value from the ecosystem database and comparing it to the number of shares held by the designated investor as pulled from the client table). The issuer may modify the minimum number from time to time.

The financial ecosystem 10 may allow issuers to stipulate additional restrictions or terms upon purchasers of the securities such that the issuers comply with various federal, state, or foreign legal requirements, as non-limiting examples. In one embodiment, these may be set as terms in the investment table of the ecosystem database.

As the financial ecosystem evolves, additional investment tools may be created for recognized QIBs and other participants, such as creating an equity index composed of multiple placements. Short selling may also be permitted under certain circumstances, as stipulated by issuers in the placement of the securities and in the secondary market.

### Broker Requirements

Broker/dealers in the financial ecosystem 10 take trade instructions from designated investors and attempt to carry out those instructions. Whether trades can be performed is subject to differing factors that are specified or set in the ecosystem database (e.g., issuer and regulatory requirements, such as maintaining fewer than 500 beneficial owners). Although, in the embodiment of FIGS. 2A and 2B, the designated investor list is described as having fewer than 500 beneficial owners, in other embodiments 500 or more beneficial owners may be allowed under specified circumstances, provided that fewer than 500 beneficial owners are present at the close of the fiscal year. Broker/dealers in the ecosystem enter into a broker agreement to allow for information dissemination to the transfer agent. Specified broker/dealers, defined as “designated liquidity providers,” are the only entities that are allowed to sell “short” within the financial ecosystem.

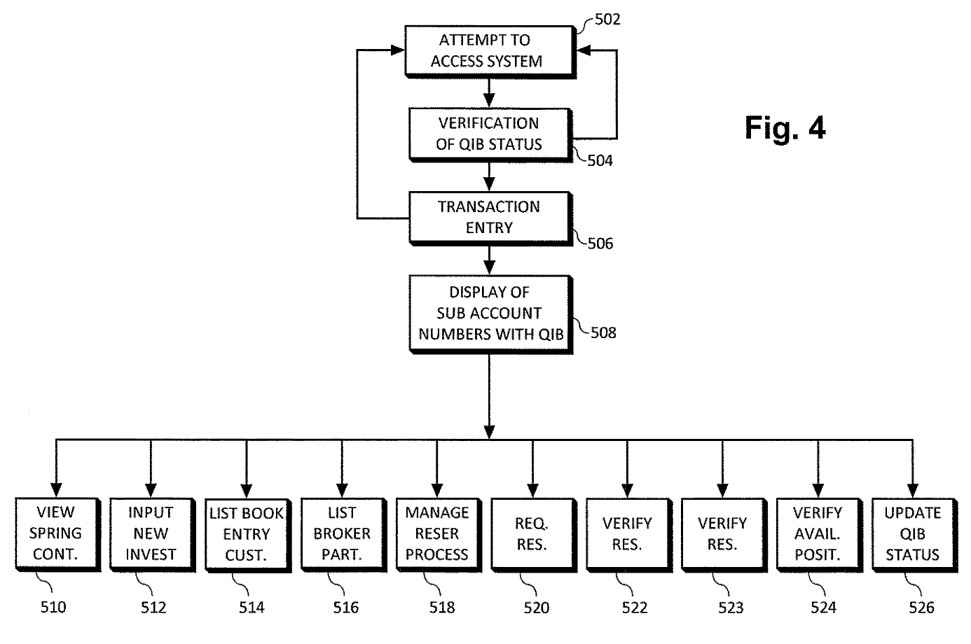

Referring to FIG. 4, which depicts a flowchart for another portion of financial ecosystem 10, brokers may attempt to access the ecosystem at block 502 to ascertain a status of a QIB, recognized QIB, or designated investor, obtain information on trade or trades, or conduct a trade on behalf of a client. At block 502, information that may be entered includes an internal brokerage account number, a recognized QIB number, an investor identification number/company index number, and an investor name. After entry of this information, the system performs a verification of the QIB status of the individual investor at block 504. If the verification is unsuccessful, the broker is then sent back via the system to block 502 to attempt to access the financial ecosystem 10 once again. If the verification is successful, then a transaction number may be entered. If the transaction number is not successfully verified, then the broker may be requested by the system to attempt once again to access the system in block 502.

If the transaction entry is verified by the system at block 506, a display of the sub-account number associated with the QIB is performed in block 508. The broker may then make additional choices. In this embodiment, a list of choices provided by the system includes viewing a springing contract at block 510 and a screen for inputting a new investor at block 512. The broker may also choose to list book-entry custodians at block 514 or list broker participants at block 516. In addition, the broker may manage the reservation process for issuers at block 518 or may request reservation for a specific security at block 520. Additionally, the broker may verify reservation for a specific security at block 522, verify or request reservation for a specific security at block 523, verify available investor positions 524 or update an investor QIB status at block 526. Additional functionality may include associating sub-accounts between client/investor, broker/dealer and custodian, being added to a wait list, viewing issuer profiles, viewing issuer additional terms, viewing issuer reports and downloading files.

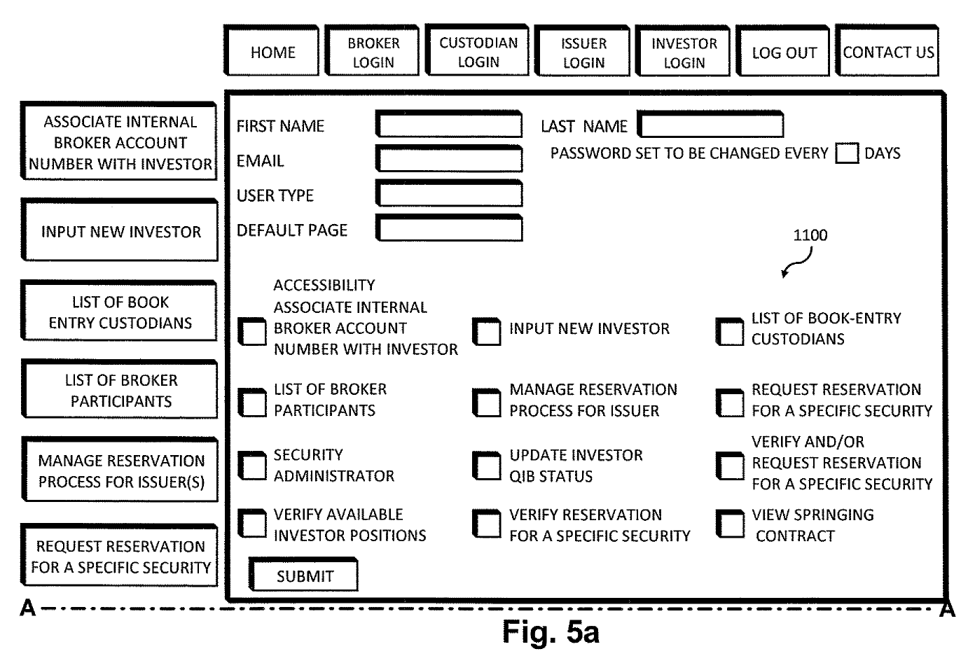

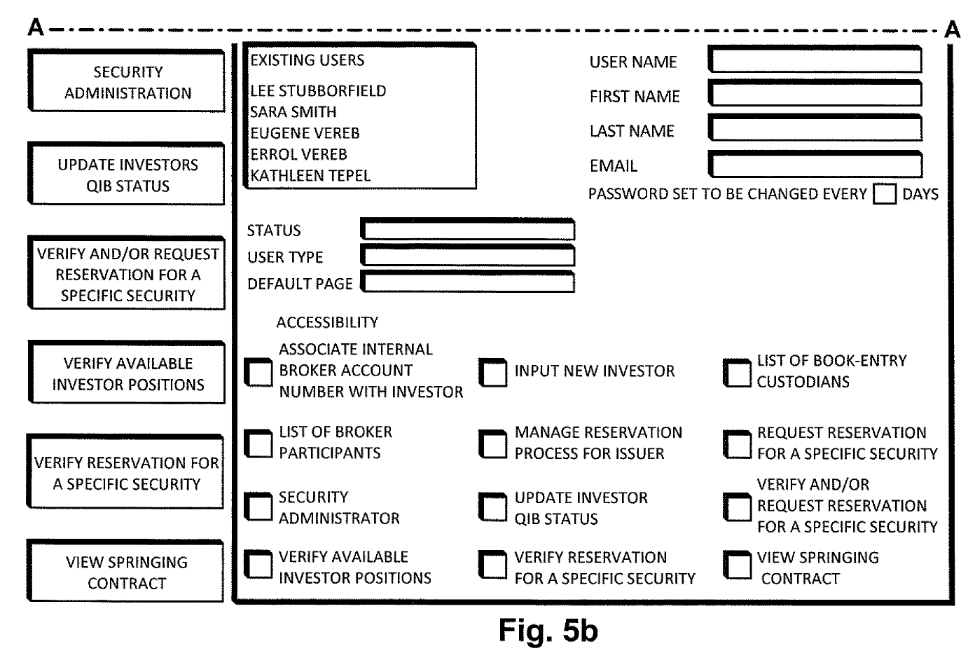

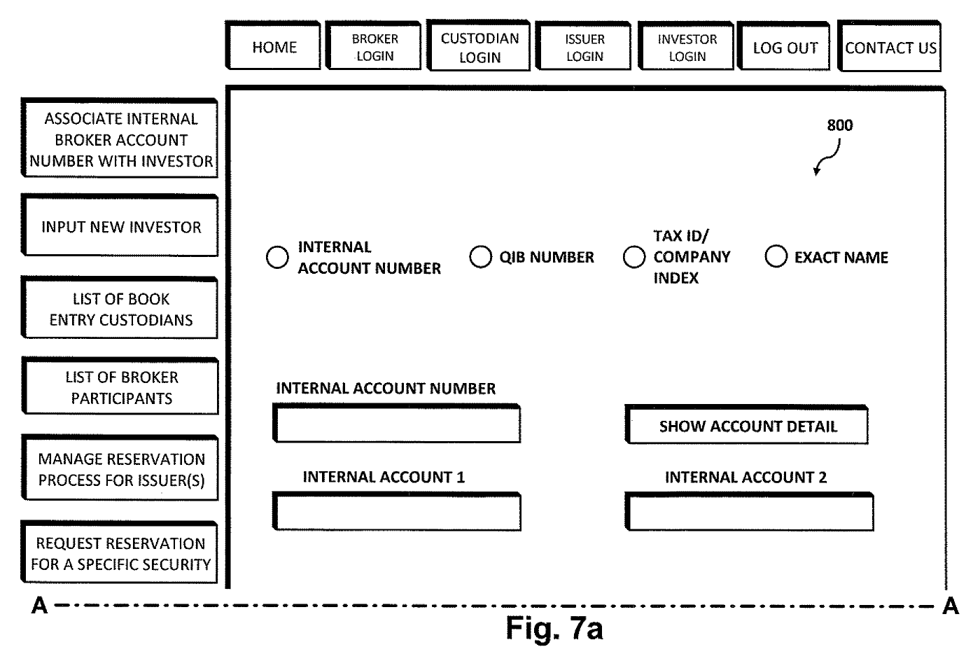

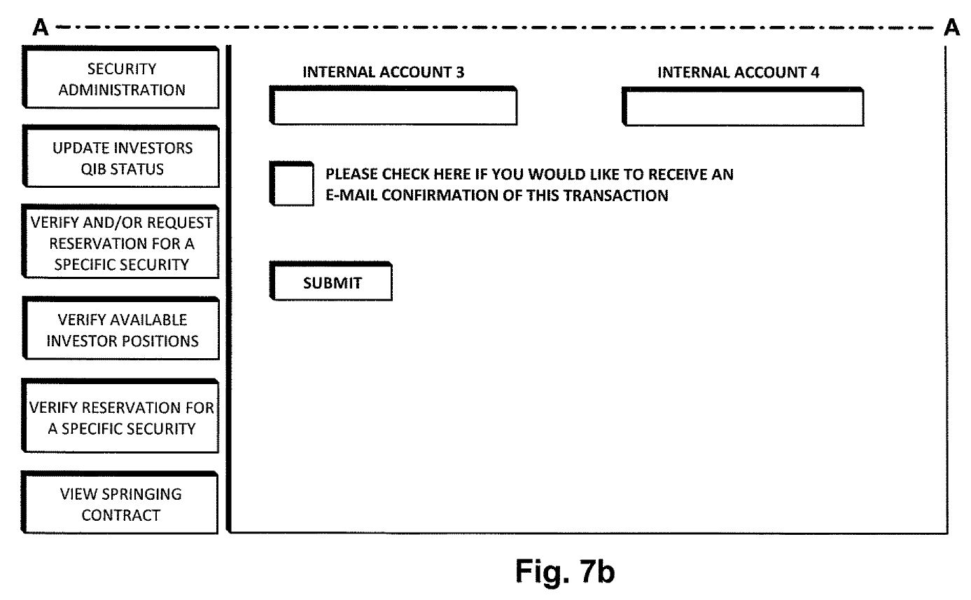

Referring to FIG. 5, a system administration screen 1100 is provided to control the financial ecosystem 10. The system administration screen 1100 provides for access to differing portions of the database formed for users, and allows a system administrator to identify new users and permit access to the new user based upon desired parameters needed by the new user. The system administration screen 1100 allows for input of the first name and the last name of the individual. Each of the screens available, described in FIGS. 7 to 16, may be highlighted for activation by the system administrator. The accessibility options of the different screens, described below, are listed as options for different users. Existing users are also listed for choice by a system administrator, indicating the accessibility options for the listed individual.

### Initial Beneficial Owner Registration Procedure

As shown in FIGS. 2A and 2B, for securities placed in the marketplace in compliance with Rule 144A, a registration procedure for the initial beneficial owner is carried out by the financial ecosystem 10 at blocks 210, 220, 230, 240, 250, 260, 270, 280, and 290. For entities that are not qualified to participate in all aspects of the ecosystem, the registration system 100 allows the broker to supply information to the ecosystem pertaining to the beneficial owner name, identification number for United States-based participants, QIB status, and expiration date for the QIB's status, as well as contact information related to the beneficial owner.

### Qualified Institutional Buyer Status

QIB status is tracked through a computer arrangement and supplied to a securities broker when registering a potential beneficial owner (e.g., an arrangement that would be in compliance with Rule 144A). In one embodiment, brokers, securities dealers, transfer agents, or the like are able to access the ecosystem and set QIB status. In another embodiment, the ecosystem is tied into broker, security dealer, transfer agent, etc. databases through database adaptors, and thereby allow the ecosystem to query those systems to select for fields indicative of QIB status and set the status itself. In another embodiment, the broker or securities dealer is responsible for identifying expiring QIB status. In yet another embodiment, the equity transfer agent tracks QIB status. If a QIB status has expired, the designated investor may continue to hold or sell shares of securities, but will be unable to purchase additional shares in the marketplace until its updated QIB status has been submitted.

Once its QIB status has been updated, the ecosystem will determine whether the QIB is a designated investor and, if so, will allow further purchasing by the QIB. If the QIB does not update its expired status, the ecosystem will allow the designated investor to sell securities that have been accumulated but will not allow purchases. QIBs may, for example, receive information from a broker/dealer such as quotations of prices for purchases of securities. But information pertaining to company financial reports and research is reserved for recognized QIBs (i.e., those who have completed the springing contract).

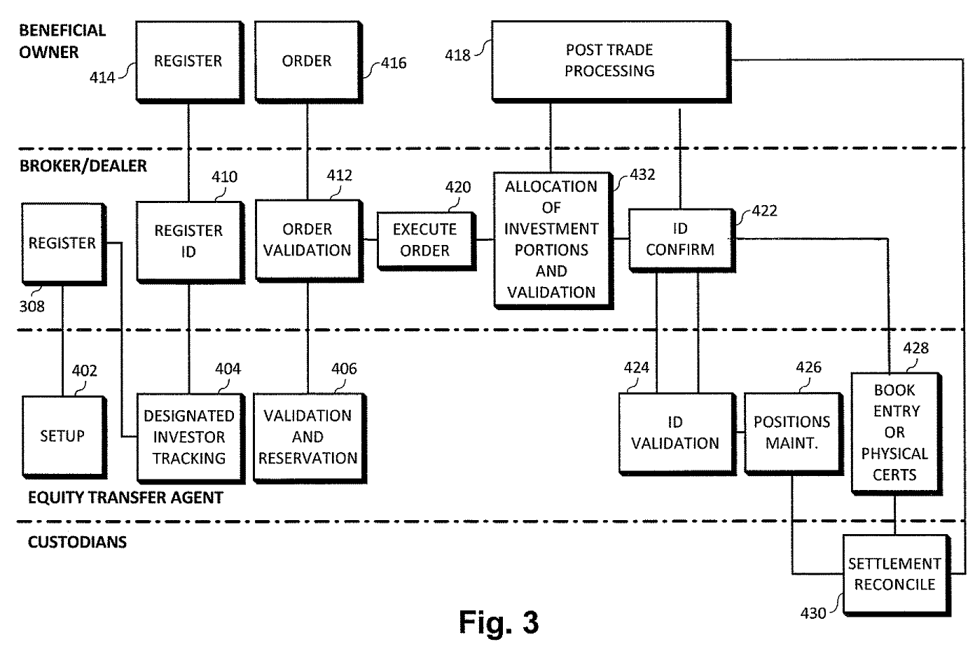

Referring to FIG. 3, a flow chart is provided for a system that handles trading of securities in compliance with SEC Rule 144A. In block 308, a broker/dealer registers a new security that so complies with the appropriate standard industry groups for the primary issuance, for example, Standard & Poor's, to obtain a CUSIP number. (“CUSIP” stands for Committee on Uniform Securities Identification Procedures. A CUSIP number identifies most securities, including stocks of all registered U.S. and Canadian companies, and U.S. government and municipal bonds.) In this embodiment, the ecosystem allows for registration of, and access to, standard industry securities.

To maintain consistency of all records, at block 402 the system notifies the equity transfer agent about the registration/setup that occurs at block 308. At block 414, clients/investors may contact their broker/dealer via the system (e.g., via e-mail request, Web-form request, facsimile request, or telephone with entries logged to the ecosystem database) to become recognized QIBs and designated investors. At block 410, broker/dealers utilize the verification system 30 in the financial ecosystem 10. A list of the designated investors that are registered with the broker/dealer at block 410 are provided to the equity transfer agent for designated investor tracking at block 404.

Upon receiving an order from a designated investor 416, the designated investors (sub-accounts) indicated on the order are validated by the broker/dealer via the system at block 412. A reservation is then created in the designated investor repository for purchase of the securities in block 406. After the designated investors (sub-accounts) on the order are validated, the system executes the order at block 420. In this embodiment, trades are completed via the system through a designated liquidity provider. Standard post-trade processing then commences at block 418, where allocations (sub-accounts) are sent to the designated liquidity provider and checked at block 432 to validate that each allocation (sub-account) is a designated investor. Post-trade processing at block 418 also provides trade notification via the system from the client/investor to custodians responsible for settlement and reconciliation at block 430.

At block 422, the designated liquidity provider sends an ID confirm via the system to the client/investor, in compliance with Rule 10b-10 under the Exchange Act. The ID Confirm is also sent to the equity transfer agent. At block 424, the designated investors are again validated for authenticity by the equity transfer agent. If the designated investor is not correctly identified, the trade is rejected via the ID Confirm and sent back to the designated liquidity provider to resolve at block 432. Next, if the designated investor is validated at block 424, then the equity transfer agent calculates positions and performs maintenance and reconciliation activities via the system at block 426. Statements of settlement reconciliation may be provided to custodians, which can also be the broker/dealer. The equity transfer agent and custodians perform settlement of trades on a book-entry or fast physical certificate process at block 428. Custodians on behalf of beneficial owners of the securities may elect to actually hold physical certificates of the securities purchased, or may elect to maintain ownership through book-entry format. The system accomplishes the settlement process at block 428. In one embodiment, settlement is accomplished within three days. The equity transfer agent may additionally move stock certificates or positions from one beneficial owner to another via the system based upon a trading arrangement, such as the ID Confirm, at block 422.

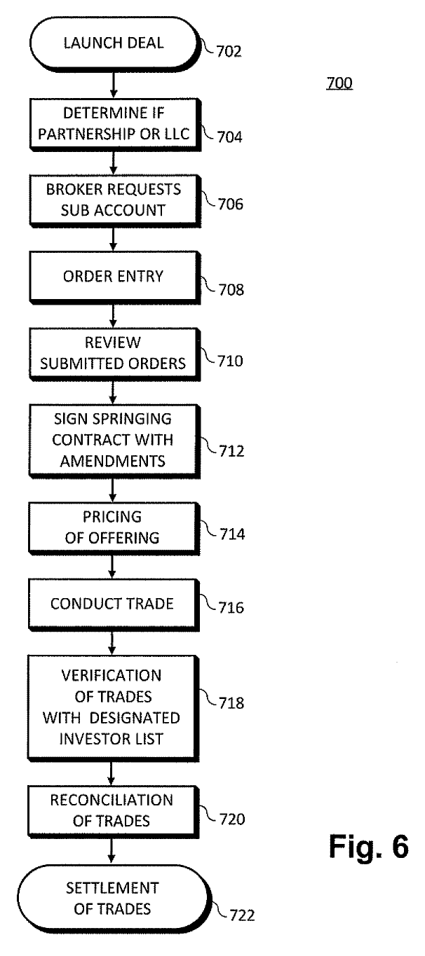

Referring to FIG. 6, a flow chart is provided for a system that handles an initial offering of securities 700 that may be used in an embodiment of present invention. A company that desires to conduct a series of transactions under Rule 144A, for example, begins proceedings for sale via the system at block 702. The entity that desires to trade securities is then investigated via the system at block 704 to determine if the entity is a partnership or a limited liability company. Next, brokers request sub-account numbers from beneficial owners at block 706 and the broker verifies if the potential investors in the company are recognized QIBs. Next, if the potential investors meet the qualifications of designated investors, then orders are entered into the system at block 708. The orders are then reviewed at block 710. Any issuer-specific additional terms are verified so that they are acknowledged by each of the designated investors at block 712. The system also verifies that a springing contract has been signed by each designated investor. The offer of securities is then priced by the issuer and lead underwriters at block 714. Trading is conducted under the system at block 716. Trades that are accomplished at block 714 are then verified at block 718 with a list of designated investors Trades are then reconciled and settled via the system at block 720. In this embodiment, designated investors or custodians for designated investors have the option to hold securities in physical certificates or in book-entry form.

### Exemplary Operating Screens

FIGS. 7 to 16 depict computer operating screens that are used to accomplish various ecosystem functions in one embodiment of the invention. All the field entry values found on the screens may be sound/stored in the ecosystem database. It will be understood that these screens are exemplary of interfaces provided by the ecosystem. Accordingly, in other embodiments, other features—including features for controlling investors, issuers, custodians, or other participants or users—may be provided in addition to those described. In one embodiment, screens are Web-based forms, with each text field linked to ecosystem database tables via XML tagging, and each button feature linked to an information server to issue server-based commands via API method/parameter HTTP conduits.

Referring to FIG. 7, an associate internal broker account number may be linked with an investor. The associate internal broker account number screen 800 allows a broker to input a new investor that does not have a sub-account number into the ecosystem. This screen 800 may also allow an investor/beneficial owner to obtain an additional sub-account number to be updated in the ecosystem or to designate a change in broker by the investor/beneficial owner.

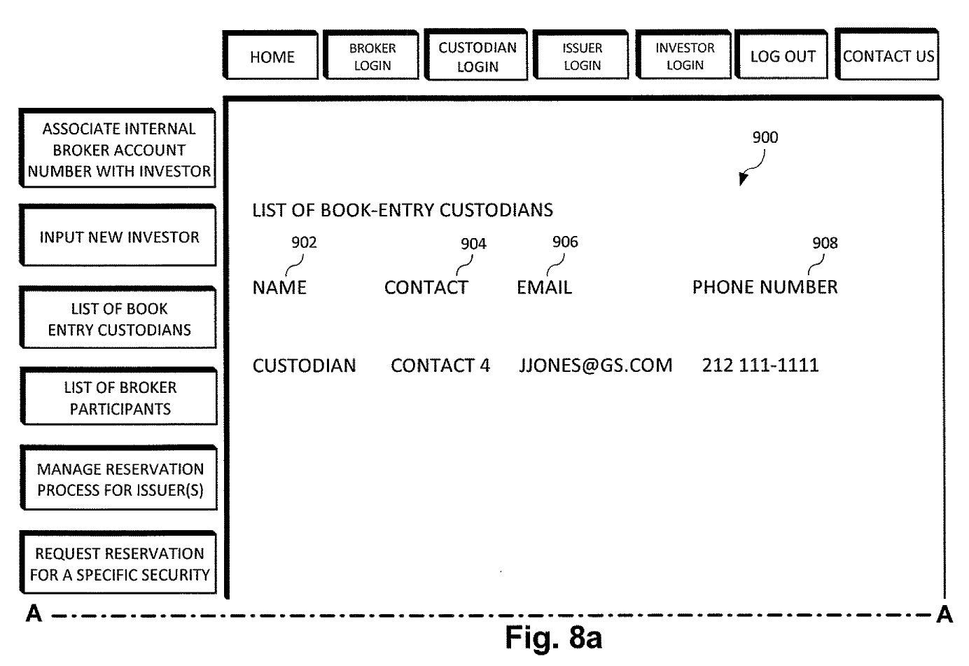

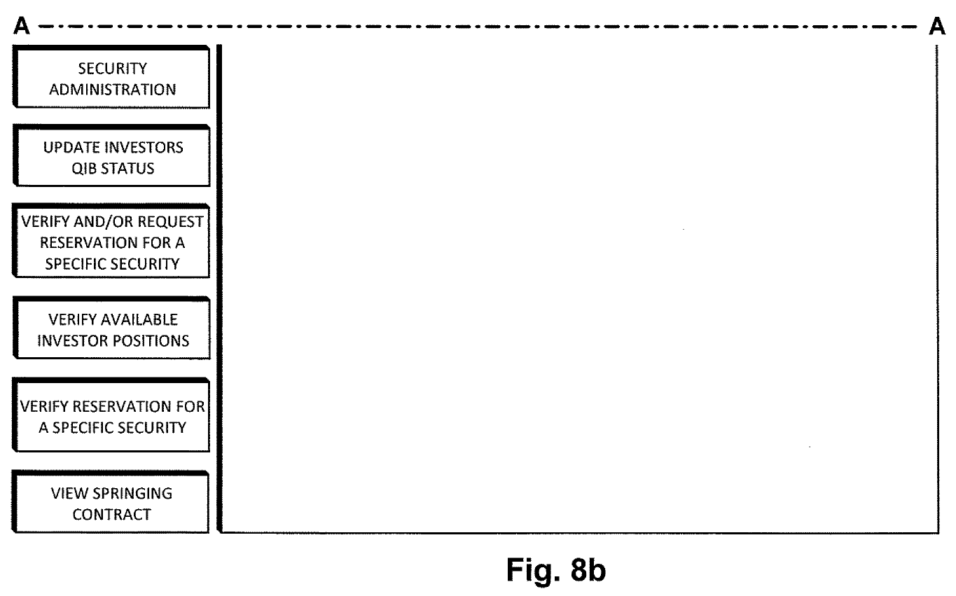

Referring to FIG. 8, a list of book-entry custodians 900 for each private securities offering may be provided to designated investors or brokers, consistent with block 514. The list of book-entry custodians includes company name 902, contact persons 904, e-mail contacts 906, and telephone numbers 908.

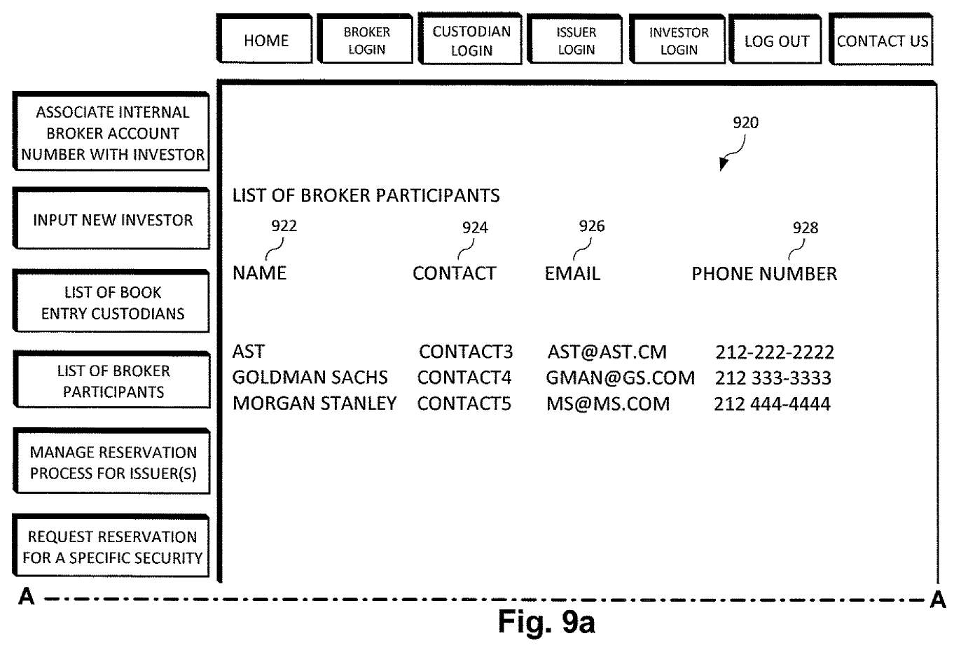

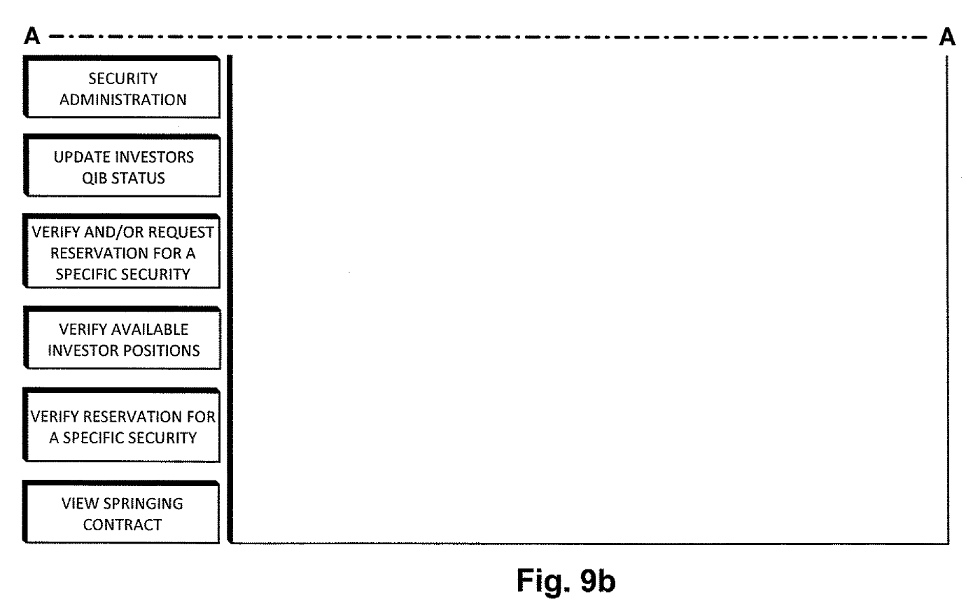

Referring to FIG. 9, a list of broker participants/designated liquidity providers 920 may be displayed to a designated investor or broker, consistent with block 516. The list 920 of broker participants can include the company name 922, contact person names 924, e-mail address 926, and telephone numbers 928.

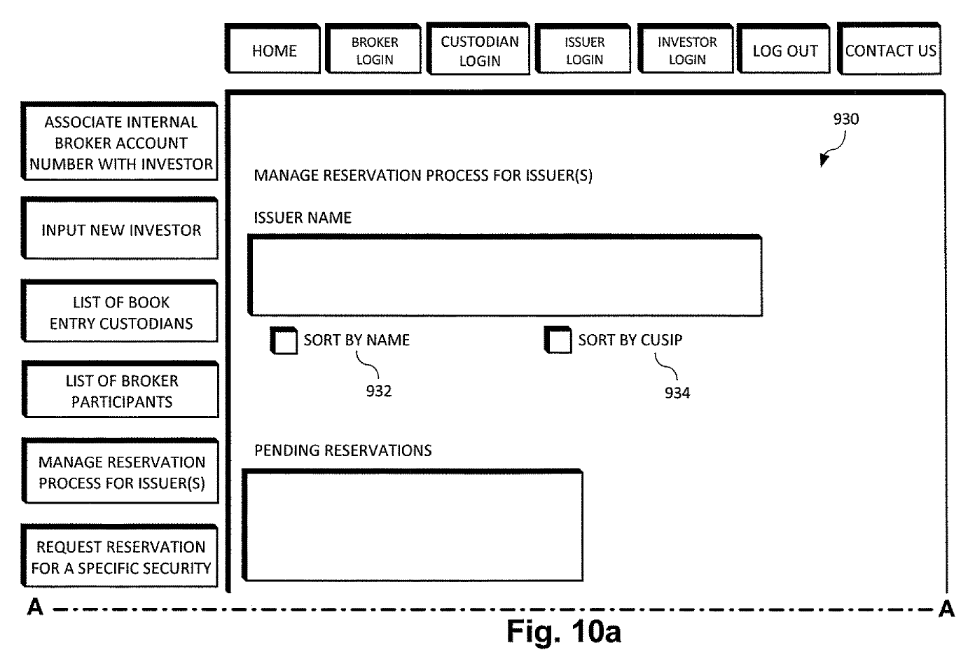

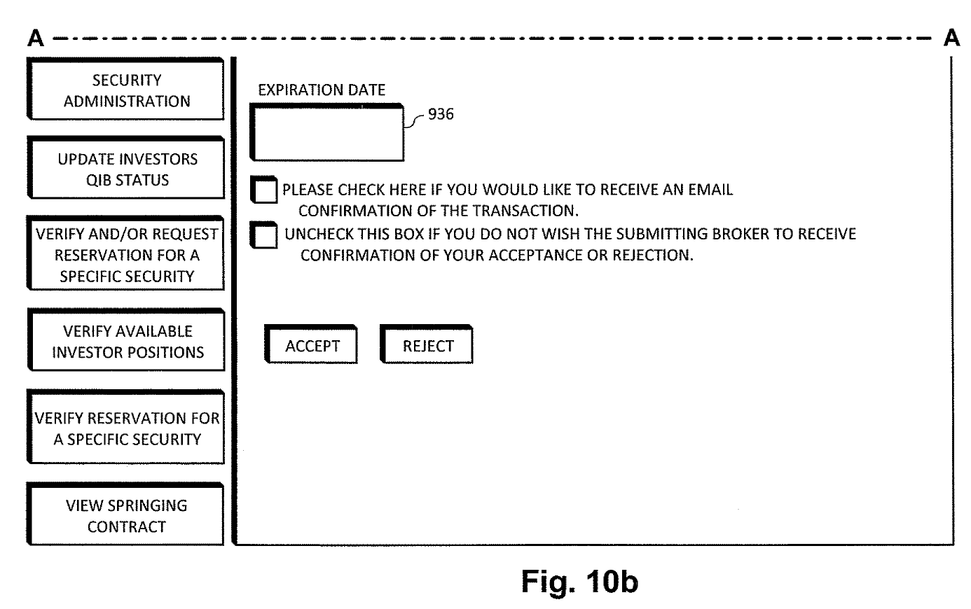

Referring to FIG. 10, a screen 930 for managing the reservation process for issuers is provided, consistent with block 518. Designated investors or brokers may select specific issuers that are sorted by name 932 or CUSIP number 934. Pending reservations are displayed for each specific issuer. Expiration dates 936 are also disclosed for each pending reservation, allowing the designated liquidity provider to determine whether reservations will be ending upon a specific date.

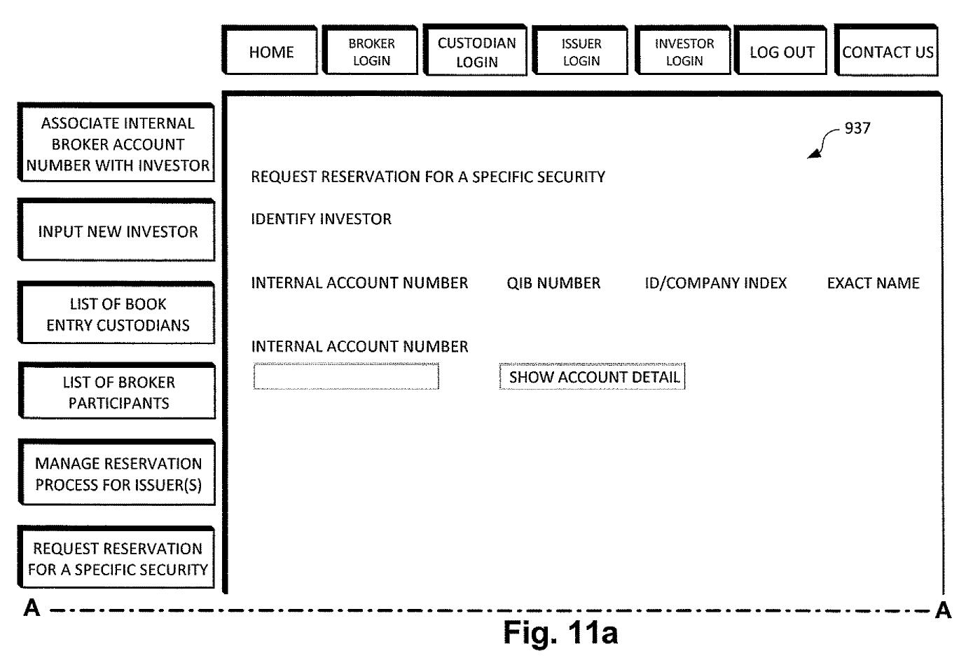

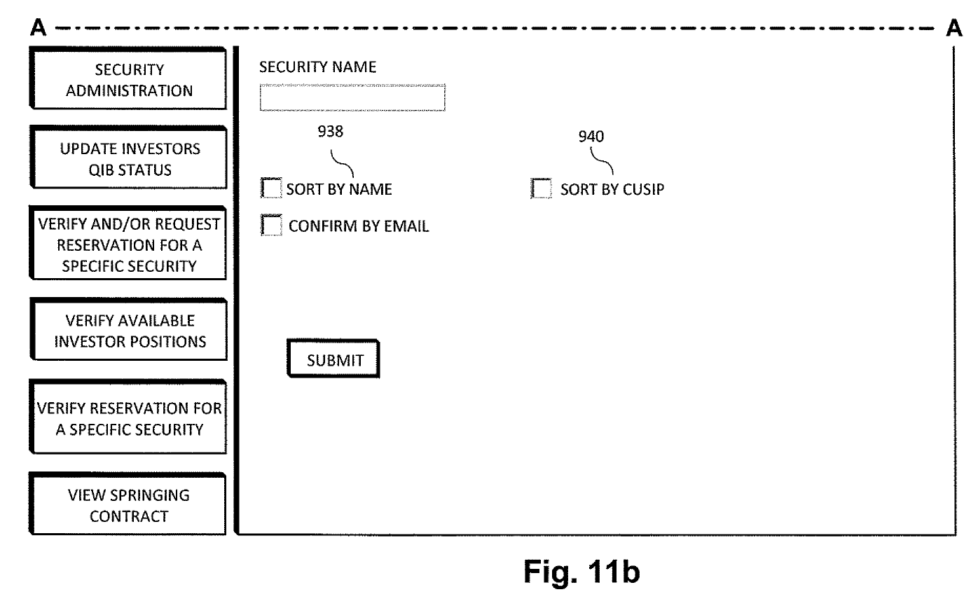

Referring to FIG. 11, a screen 937 for managing a reservation request for a specific security is provided. A reservation for a specific security may be performed via the ecosystem by a broker, for example, consistent with block 520. The broker is prompted to select a specific security from a drop-down list (sorted by name 938 or CUSIP 940, as selected by the broker user). If issuer approval is required, upon submitting a successful request to purchase an issuer's securities, the issuer is provided with a message indicating that it must approve the reservation. If the broker submits a request but the recognized QIB already has a reservation from this or another broker, or already owns shares in the issuer, a notification will be prepared indicating that the recognized QIB is a pre-existing designated investor and may purchase securities. If an issuer does not require approval of reservation requests, a reservation identification number (designated investor number) is created. The designated investor number expires after a pre-set number of days specified by the issuer. If a broker attempts to request a reservation for an entity that has no associated internal account number, the broker will be requested either to input an internal account number or to take appropriate measures to create an internal account number. Additionally, if the broker attempts to request a reservation in an issue, but the investor has not returned a springing contract, the broker will receive notification via the ecosystem that a deficiency exists and that the springing contract should be completed. If all reservations for a given issue are taken, the broker will be notified that no reservations are available at this time.

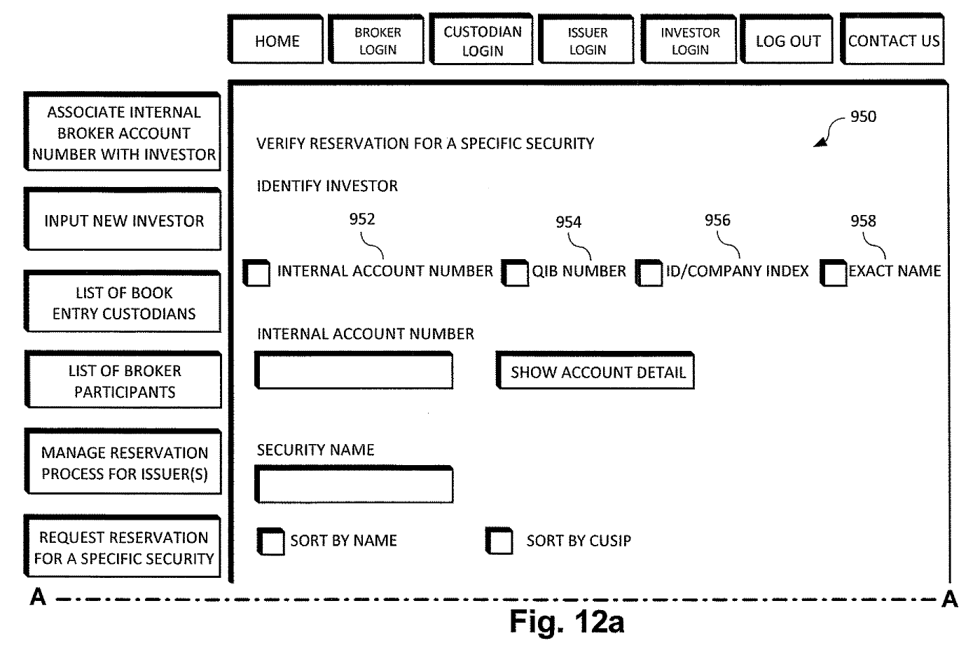

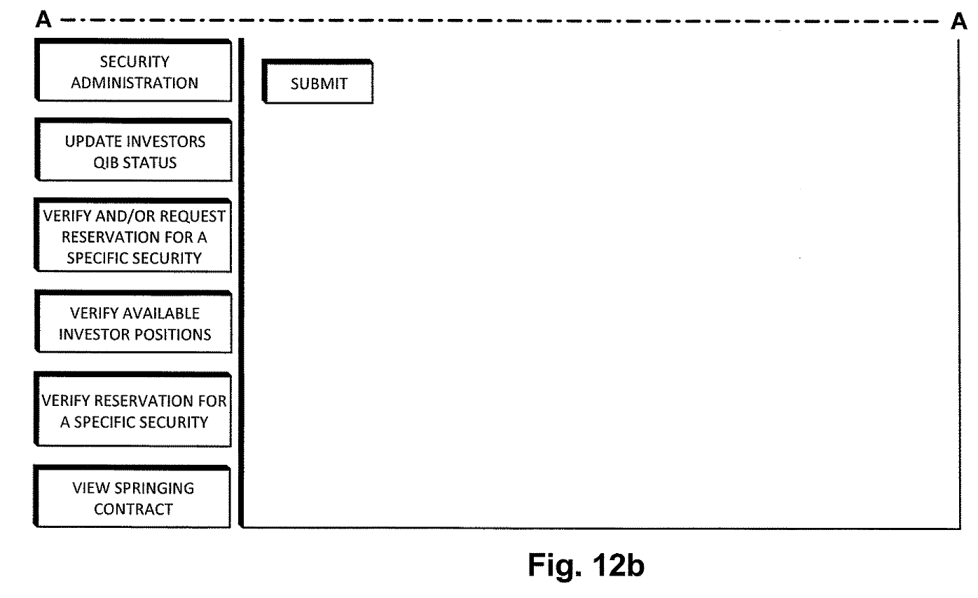

Referring to FIG. 12, a reservation verification screen 950 is provided, allowing a broker to verify a reservation for a specific security by a specific QIB, consistent with block 522. This function may be used, for example, as a check before inputting a trade into the system. The broker may identify an investor by an internal account number 952, a recognized QIB number 954, an identification number/company index number 956, or by an exact name 958. The security to be reserved may be identified in a drop down menu. If a recognized QIB has a valid reservation (i.e., is a designated investor), a message is provided via the ecosystem to the broker that purchases may be made by this recognized QIB. If the recognized QIB has requested a reservation, but the reservation is still pending issuer approval, the broker is notified of this status. If a QIB has not signed the springing contract, the ecosystem notifies the broker of this deficiency.

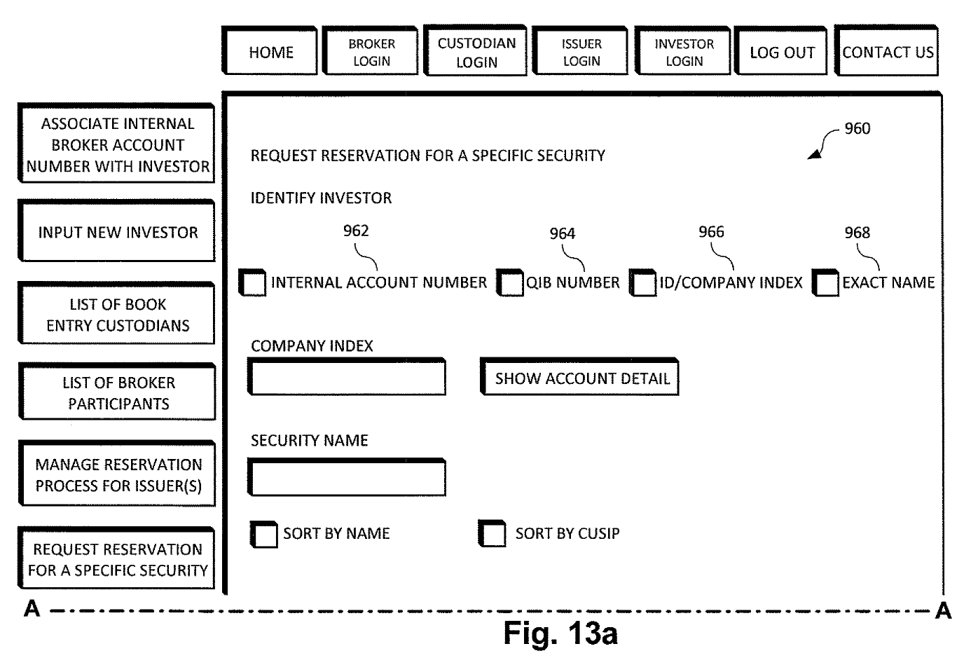

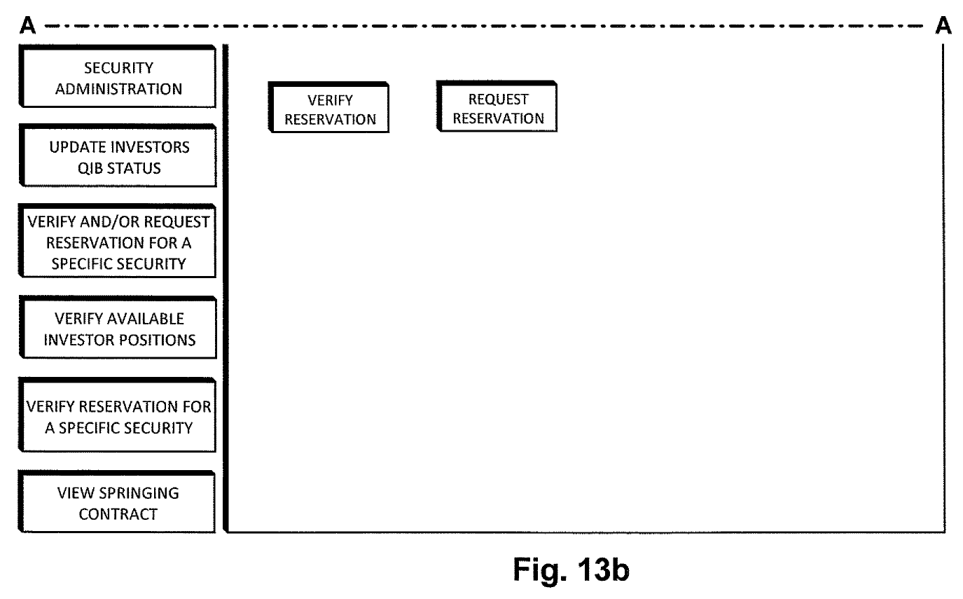

Referring to FIG. 13, a reservation verification and request screen 960 is provided, allowing a broker to both verify and request a reservation for a specific security issue, consistent with block 523. The broker may identify an investor by an internal account number 962, a recognized QIB number 964, an identification number/company index 966, or by an exact name 968. The security to be reserved may be identified in a drop down menu.

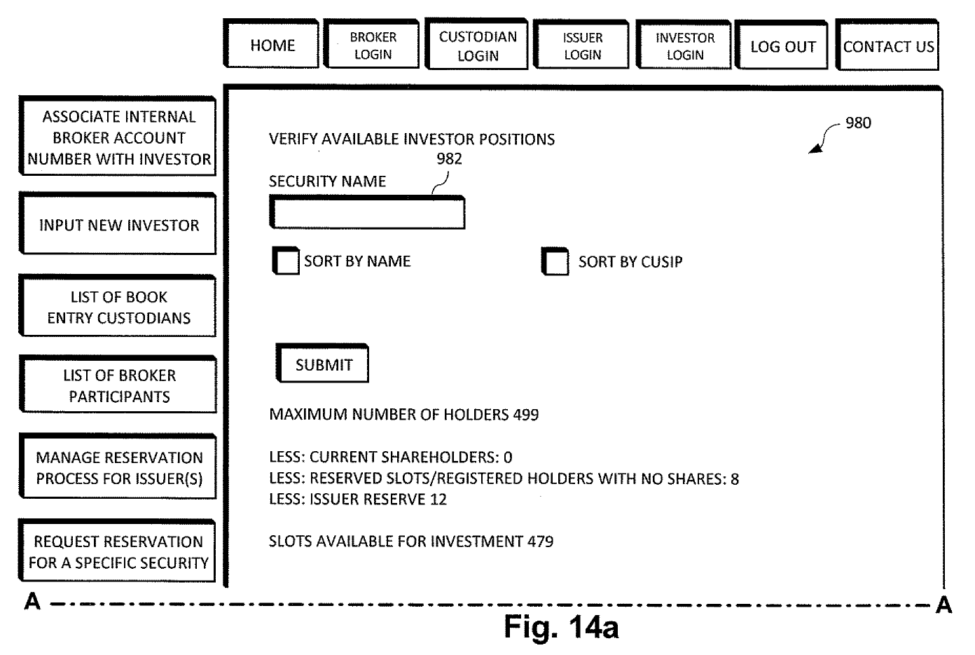

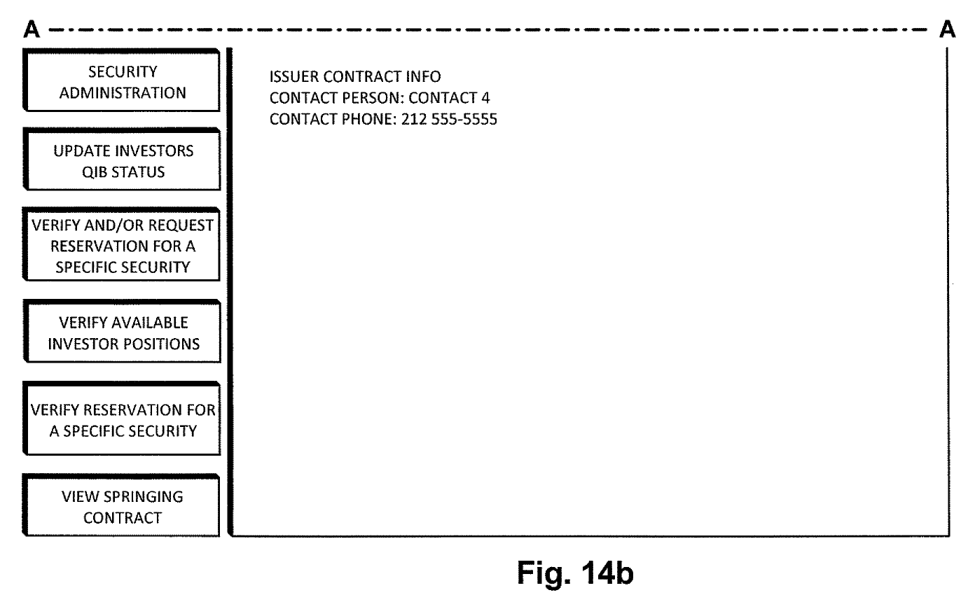

Referring to FIG. 14, a verify available investor positions screen 980 is provided, permitting a broker to verify an available investor position regarding a particular security 982, consistent with block 524.

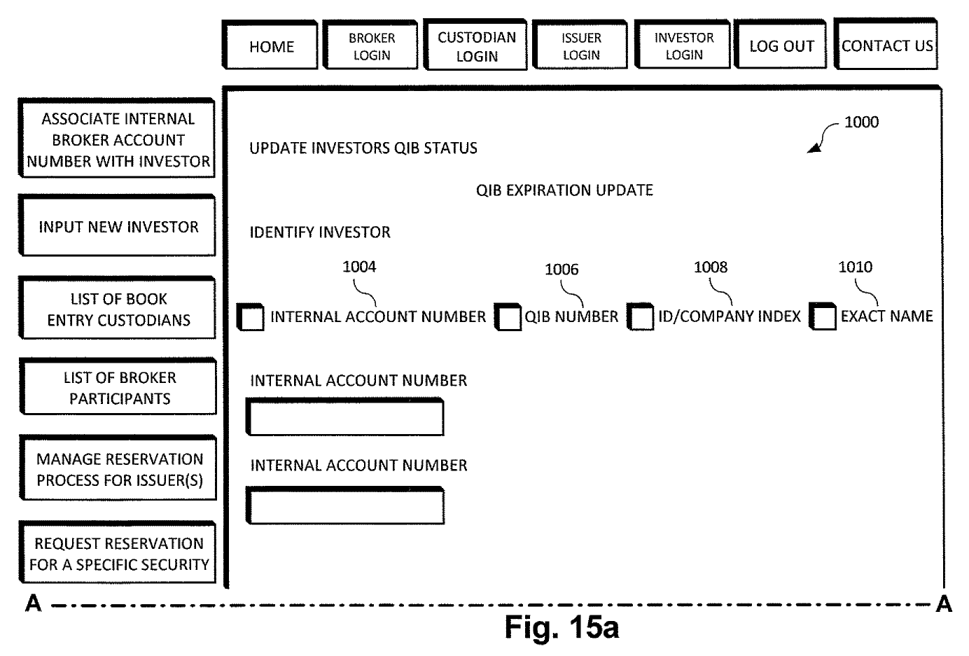

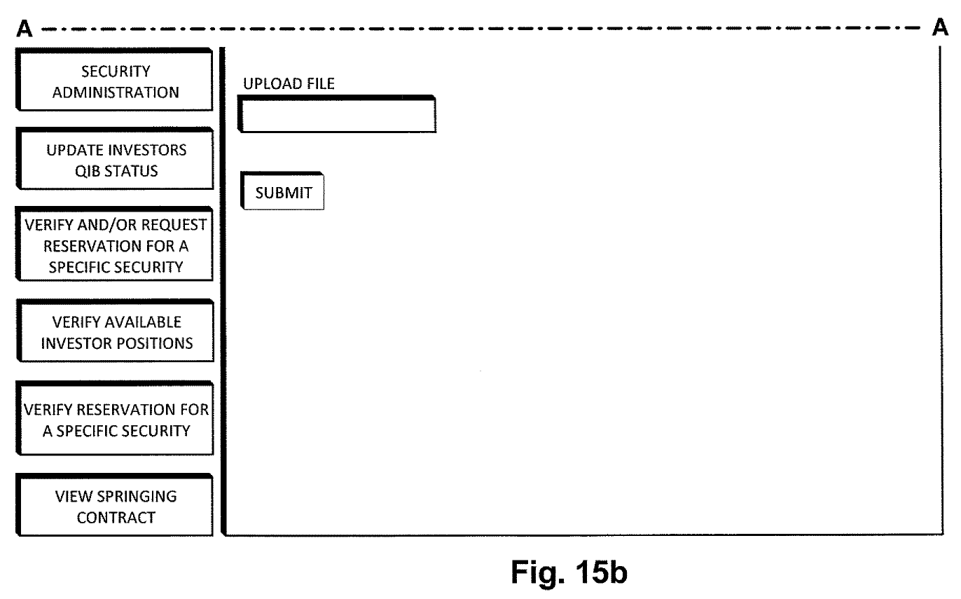

Referring to FIG. 15, an update investor's QIB status screen 1000 is provided, permitting a broker to update information regarding the QIB status for a client, for example, consistent with block 526. Information that may be obtained from a broker to accomplish this includes inputting an internal account number 1004, a recognized QIB number 1006, an identification number/company index number 1008, or an exact name 1010.

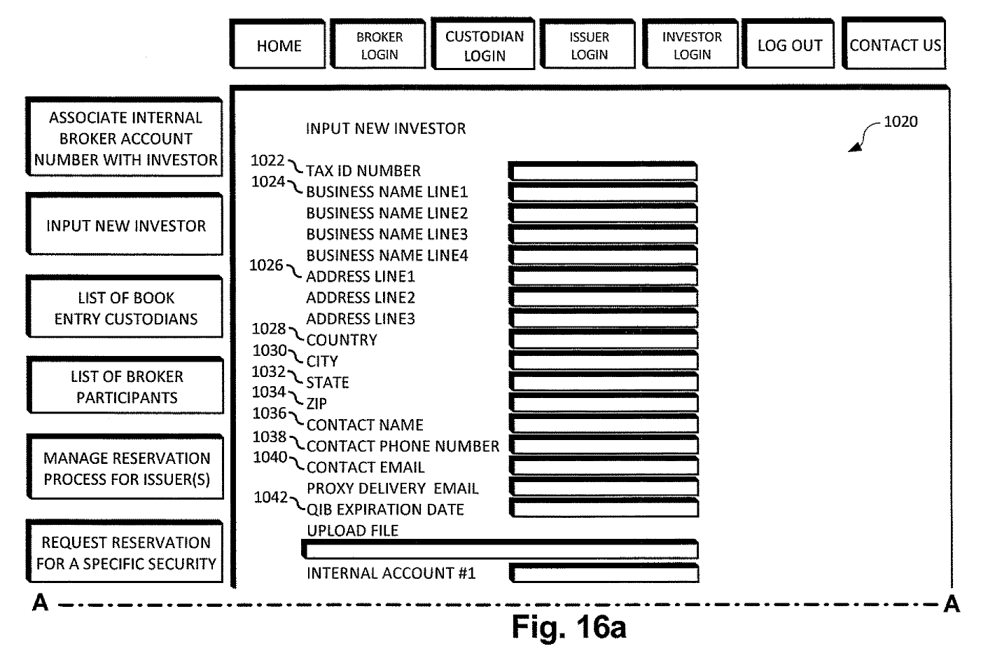

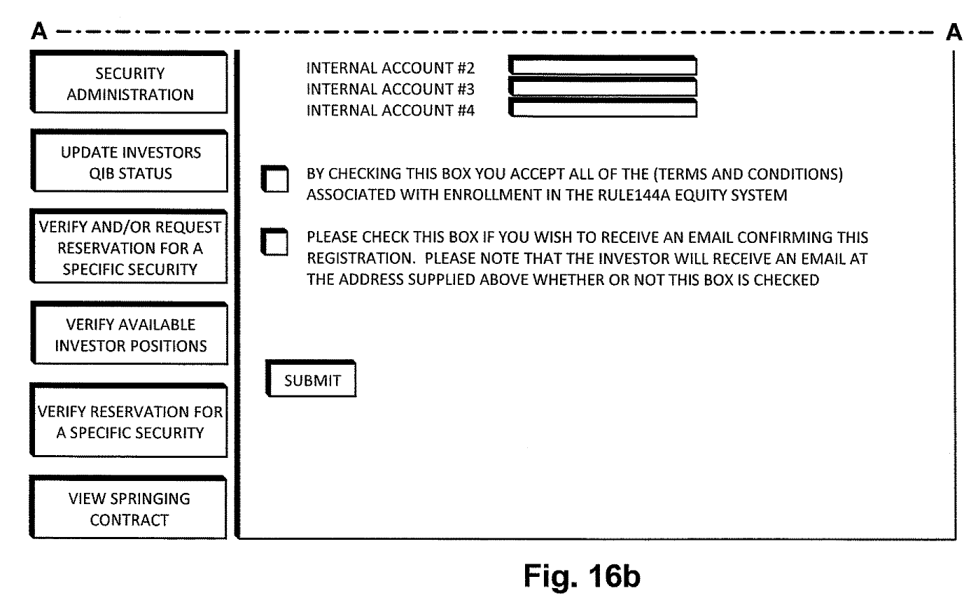

Referring to FIG. 16, an input new investor screen 1020 is provided, allowing a broker to input a new investor into the ecosystem, consistent with block 512. Information that may be input into the new investor screen may be an identification number 1022, an advisor/business name 1024, a business address 1026, a country 1028, a city 1030, a state 1032, and a zip code 1034. The new investor may also include a contact individual 1036, a contact telephone 1038, a contact e-mail address 1040, and a QIB expiration date 1042.

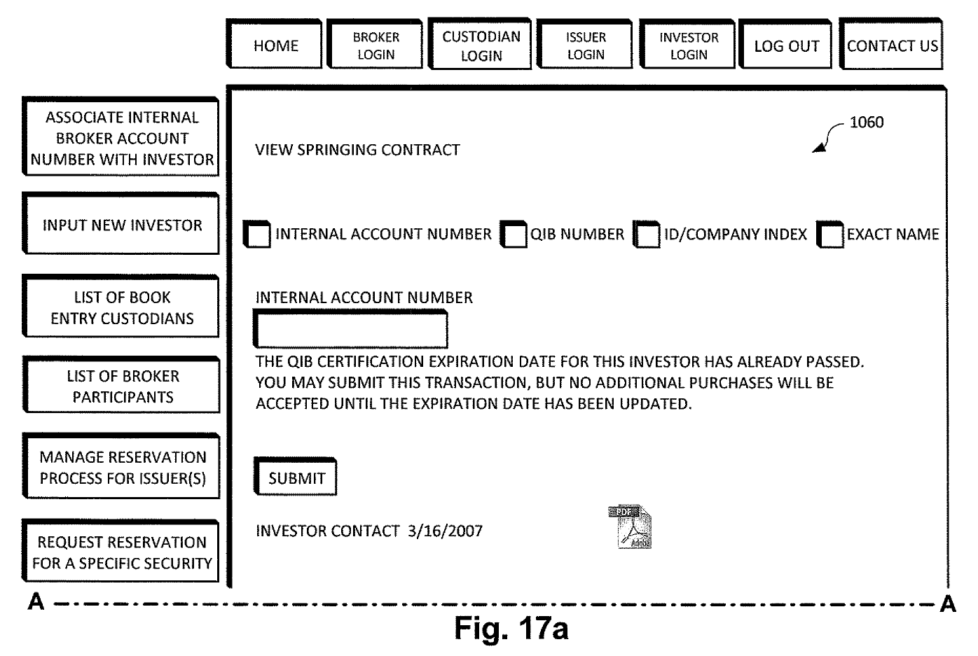

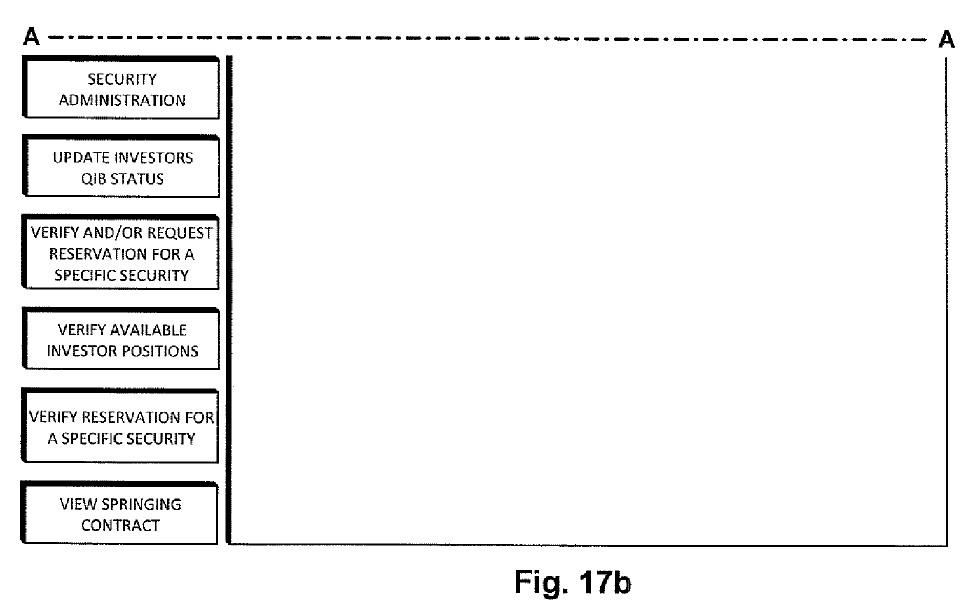

Referring to FIG. 17, a view springing contract screen 1060 is provided, allowing the ecosystem to display a springing contract, consistent with block 510. The springing contract viewed, for example, by the broker may be a stand-alone document or may incorporate issuer-specific amendments. If a springing contract has previously been signed, then notification of that fact may be displayed along with the executed springing contract. Any issuer-specific amendments are also displayed. The broker may identify an investor by an internal account number, a recognized QIB number, an identification number/company index, or an exact name.

### Systems Interaction

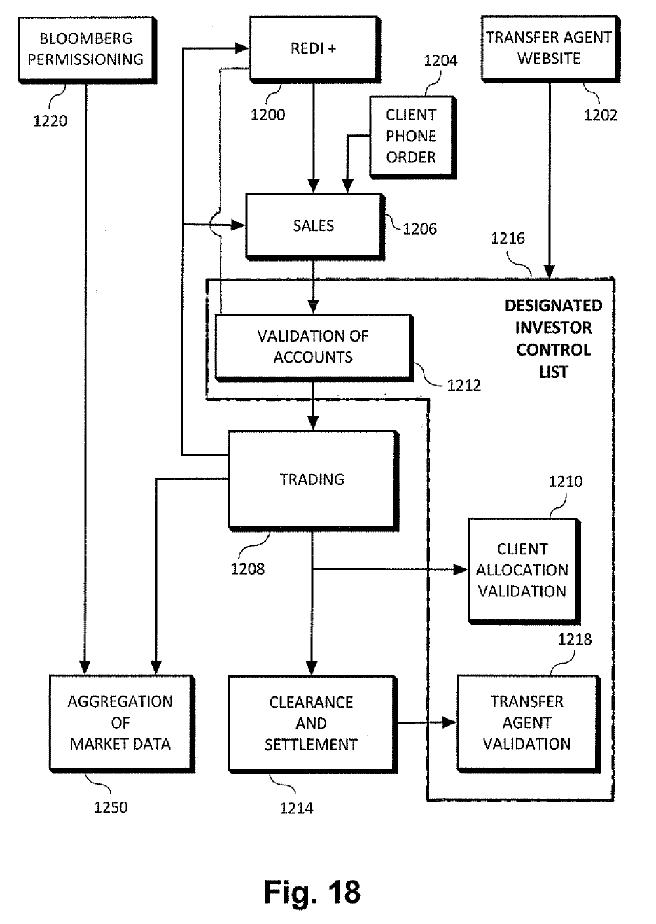

FIG. 18 depicts a trading systems interaction diagram for the financial ecosystem 10. Through an electronic trading platform 1200—in this embodiment, the REDI+trade-execution platform—users enter electronic orders into the ecosystem via sales system 1206. The ecosystem may also allow orders to be accepted through other means, such as a phone system 1204. In this embodiment, phone orders are taken and incorporated in the sales system 1206 along with electronic orders. Orders received through the electronic trading platform 1200 or phone system 1204 are validated (pre-trade) by the accounts and sub-account validation system 1212 against the designated investor list 1216. Validated orders can then be executed in the trading system 1208. Because clients may ask for allocation to an account other than that provided for validation at time of order entry, allocation system 1210 incorporates (post-trade) validation of accounts against the designated investor list 1216. In one embodiment, such lists may be generated by selecting client-account identifiers in an investment table of the ecosystem database. Alternatively, such field entries may be set as investment-table field entries. Clearance and settlement process 1214 incorporates transfer agent (post-trade) validation of accounts 1218 against the designated investor list 1216. Transfer agent website 1202 provides interactions with transfer agent, including setting of the designated investor list 1216.

Market data generated by order-trading in the trading system 1208, such as last sale price, can be disseminated to an external market data aggregator 1250, such as Bloomberg. Market data not specific to orders and executions, such as indicative quotes, can also be disseminated to external market data aggregator 1250. External market data aggregator 1250 can accept market data from multiple brokers/dealers. Access to aggregated market data is subject to proper permissioning as required by the ecosystem, for example Bloomberg permissioning 1220, to restrict availability of the data to QIB users only. The same market data that is available to the external market data aggregator can also be available to internal proprietary systems, such as REDI+ (or another electronic trading platform 1200), as long as the internal proprietary systems ensure proper permissioning as required by the ecosystem.

Using a financial ecosystem according to the invention that permits placement of private securities in compliance with SEC Rule 144A significantly benefits issuers of such securities by providing a trading platform for such securities. The financial ecosystem provides an alternative to initial public offerings to public markets. One significant benefit for issuers is the capability of raising capital faster and more cost-effectively than with conventional private-placement practices, because the placement of these securities does not have to meet all SEC requirements for registration of public corporations. Investors also benefit from increased liquidity in the private securities market, since investors can sell/trade the securities with other recognized QIBs.

In the financial ecosystem 10, if a QIB wishes to interact with multiple brokers, a single computer system will link each of the QIB accounts to the original registration of the securities. By performing this function, the securities will always have a specific number of designated investors less than the limit set by the issuer. Furthermore, the QIB will always be listed as a designated investor once for each individual securities offering. A maximum number of designated investors is maintained by the equity transfer agent by eliminating potential duplicate entries on the designated investor list. If the identification number or identification information entered for a QIB matches existing information previously entered into the registration system 100 or other computer systems used by a designated investor, the information is identified as being duplicate information so that redundant designated investor information is prohibited. More than one computer system may be used in embodiments of the invention. If so, each of the computer systems (e.g., ecosystem controllers) may rectify the overall number of investors for a specific issue of securities, thereby maintaining assurances that the ultimate number of investors is fewer than 500 at any given time.

In this embodiment, the designated investor number may be provided to the broker so that the recognized QIB can verify information. To transfer easily information related to securities offerings, each issuer of securities using the ecosystem is provided with an issuer computer Web site/access point. The issuer computer Web site allows designated investors to review terms and financial information forwarded by the issuing entity. The Web site may also provide formal requirements necessary for designated investors to complete in order to trade in the securities offered. Documentation that includes the formal requirements is forwarded by the issuer on the Web site. Dividends paid by the issuer during the time period in which a designated investor holds the securities are distributed to the designated investor through the Web site. In one embodiment, the American Stock Transfer & Trust Company is used as the transfer agent.

In another embodiment of the invention, the number of designated liquidity providers may be chosen, such that a maximum or minimum number of designated liquidity providers are established for the overall market. In one embodiment, one designated liquidity provider is present for all trades for bid/ask orders. As provided by the ecosystem, the designated liquidity providers may sell short within established system. The designated liquidity providers may be banks.

In another embodiment of the invention, the ecosystem incorporates or interacts with a crossing network, such as Liquidnet, Pipeline, POSIT, SIGMA X, or the like.

One or more embodiments of the invention may:
service the private-placement market—and other markets that are limited to a class or classes of investors that meet certain criteria—while providing increased liquidity for investors and issuers of securities through the maintenance of various procedures and standards; such procedures and standards may include information reporting and dissemination processes that are similar to those in the public markets (e.g., reports of issuers regarding their results of operations and financial condition and reports regarding trading in the secondary market);
reduce expenses incurred during handling of products, such as securities, in private placements;
enable an ecosystem participant to promptly know whether another potential participant meets specific criteria, for example, when a broker/dealer, issuer, or seller needs to know whether a potential investor is a QIB when trading in a QIB-only environment;
enable market participants to receive information, such as information related to trading activities, on the other participants, while maintaining the privacy needs of such participants;
a disseminate specified information to standard information sources, such as Bloomberg reporting services, while limiting the availability of such information to participants and potential participants in the ecosystem;
enable issuers and their agents to monitor the trading and other activities to ensure that sales do not result in the securities being held by more than a specified number of persons, or by persons outside a specified class or classes of persons;
allow issuers to place qualifications upon investors/QIBs for various regulatory considerations and objectives, including for example, regulatory requirements that limit foreign ownership;
provide for efficient settlement of trades while maintaining compliance with selected restrictions and objectives; or
enable market participants to monitor and enforce objectives such that participants who do not comply with the prerequisites and qualifications are precluded from participation.

### Ecosystem Controller

FIG. 19 is a block diagram that illustrates an ecosystem embodying the invention implemented as an ecosystem controller 1901. In this embodiment, the ecosystem controller 1901 may serve to aggregate, process, store, search, serve, identify, instruct, generate, match, or facilitate interactions with a computer through securities-related technologies, or other related data.

Users—which may be people or other systems—typically engage information-technology systems (e.g., computers) to facilitate information processing. In turn, computers employ processors to process information; such processors are often referred to as central processing units (CPUs). A common form of processor is referred to as a microprocessor. CPUs use communicative signals to enable various operations. Such communicative signals may be stored or transmitted in batches as program or data components facilitate desired operations. These stored instruction-code signals may engage the CPU circuit components to perform desired operations. A common type of program is a computer operating system, which is typically executed by CPU on a computer. The operating system enables and facilitates users to access and operate computer information technology and resources. Common resources employed in information-technology systems include: input and output mechanisms through which data may pass into and out of a computer; memory storage into which data may be saved; and processors by which information may be processed. Information-technology systems are often used to collect data for later retrieval, analysis, and manipulation, which is commonly facilitated through a database program. Information-technology systems also commonly provide interfaces that allow users to access and operate various system components.

In one embodiment, the ecosystem controller 1901 may be connected to or communicate with entities such as: one or more users from user input devices 1911; peripheral devices 1912; a cryptographic processor device 1928; and a communications network 1913.

Networks are commonly regarded to comprise the interconnection and interoperation of clients, servers, and intermediary nodes in a graph topology. As used in this disclosure, “server” refers generally to a computer, other device, program, or combination of those that processes and responds to the requests of remote users across a communications network. Servers serve their information to requesting “clients.” As used in this disclosure, the term “client” refers generally to a computer, other device, program, or combination of those that is capable of processing and making requests and obtaining and processing any responses from servers across a communications network. A computer, other device, program, or combination of those that facilitates, processes information and requests, and furthers the passage of information from a source user to a destination user is commonly referred to as a “node.” Networks are generally regarded to facilitate the transfer of information from source points to destinations. A node specifically tasked with furthering the passage of information from a source to a destination is commonly called a “router.” There are many forms of networks, such as Local Area Networks (LANs), Pico networks, Wide Area Networks (WANs), and Wireless Networks (WLANs). For example, the Internet is generally regarded as an interconnection of a multitude of networks in which remote clients and servers may access and interoperate with one another.

The ecosystem controller 1901 may be based on common computer systems may comprise components such as a computer systemization 1902 connected to memory 1929.

### Computer Systemization

A computer systemization 1902 may comprise a clock 1930, central processing unit (CPU) 1903, a read-only memory (ROM) 1906, a random access memory (RAM) 1905, and an interface bus 1907. In this embodiment, all are interconnected or communicate through a system bus 1904. Optionally, the computer systemization may be connected to an internal power source 1986. Optionally, a cryptographic processor 1926 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, be received, and cause return- or reply-signal communications beyond the instant computer systemization to: communications networks, input devices, other computer systemizations, peripheral devices, and the like. Of course, any of the above components may be connected directly to one another, connected to the CPU, or organized in numerous variations employed as exemplified by various computer systems. The computer systemization(s) 1902 may be implemented in multiple components or modules.

The CPU comprises at least one high-speed data processor adequate to execute program components for executing user- or system-generated requests. The CPU may be one or more microprocessors, such as AMD's Athlon, Duron, or Opteron; IBM's or Motorola's PowerPC; IBM's or Sony's Cell processor; Intel's Celeron, Itanium, Pentium, Xeon, or XScale; or the like. The CPU interacts with memory through signal passing through conductive conduits to execute stored signal program code according to conventional data processing techniques. Such signal passing facilitates communication within the ecosystem controller and beyond through various interfaces. Should system requirements dictate faster processing, parallel, mainframe, or super-computer architectures, or a combination of architectures, may similarly be used. Alternatively, should deployment requirements dictate greater portability, small units such as Personal Digital Assistants (PDAs) or the like may be used.

### Power Source

The power source 1986 may be of any standard form for powering small electronic circuit board devices such as the following power cells: alkaline, lithium hydride, lithium ion, lithium polymer, nickel cadmium, solar cells, or the like. Other types of AC or DC power sources may be used as well. For solar cells, in one embodiment, a case that encloses the computer systemization 1902 provides an aperture through which the solar cell may capture photonic energy. The power cell 1986 is connected to at least one of the interconnected subsequent components of the ecosystem, thereby providing an electric current to all subsequent components. In one example, the power source 1986 is connected to the system bus component 1904. In an alternative embodiment, an outside power source 1986 is provided through a connection across the Input/Output (I/O) interfaces 1908. For example, a USB or IEEE 1394 connection carries both data and power across the connection and is therefore a suitable source of power.

### Interface Adapters

Interface bus(ses) 1907 may accept, connect, or communicate to a number of interface adapters, conventionally although not necessarily in the form of adapter cards, such as: I/O interfaces 1908, storage interfaces 1909, network interfaces 1910, or the like. Optionally, cryptographic processor interfaces 1927 similarly may be connected to the interface bus. The interface bus provides for the communications of interface adapters with one another as well as with other components of the computer systemization 1902. Interface adapters are typically adapted for a compatible interface bus. Interface adapters conventionally connect to the interface bus via a slot architecture. Conventional slot architectures may be employed, such as: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), or the like.

Storage interfaces 1909 may accept, communicate, or connect to a number of storage devices such as: storage devices 1914, removable disc devices, or the like. Storage interfaces may employ connection protocols such as: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), or the like.

Network interfaces 1910 may accept, communicate, or connect to a communications network 1913, through which the ecosystem controller is accessible via remote clients 1933b (e.g., computers with web browsers) by users 1933a. Network interfaces may employ connection protocols such as: direct connect, Ethernet (thick, thin, twisted pair 10/100/1000 Base T, or the like), Token Ring, wireless connection (such as IEEE 802.11a-x), or the like. A communications network may be any one or any combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as a Wireless Application Protocol (WAP), I-mode, or the like); or the like. A network interface may be regarded as a specialized form of an input/output interface. Further, multiple network interfaces 1910 may be used to engage with various communications network types 1913. For example, multiple network interfaces may be employed to allow for the communication over broadcast, multicast, or unicast networks.

I/O interfaces 1908 may accept, communicate, or connect to user input devices 1911, peripheral devices 1912, cryptographic processor devices 1928, or the like. I/O interfaces 1908 may employ connection protocols such as: Apple Desktop Bus (ADB); Apple Desktop Connector (ADC); audio (e.g., analog, digital, monaural, RCA, stereo); IEEE 1394a-b; infrared; joystick; keyboard; midi; optical; PC AT; PS/2; parallel; radio; serial; USB; video interface (e.g., BNC, coaxial, composite, digital, Digital Visual Interface (DVI), RCA, RF antennae, S-Video, VGA); wireless; or the like. A common output device is a video display, which typically comprises a Cathode Ray Tube (CRT) or Liquid Crystal Display (LCD) monitor with an interface (e.g., DVI circuitry and cable) that accepts signals from a video interface. A television set, which accepts signals from a video interface, may also be used. The video interface composites information generated by the computer systemization 1902 and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable).

User input devices 1911 may be card readers, bar-code readers, dongles, fingerprint readers, gloves, graphics tablets, joysticks, keyboards, mouse (mice), remote controls, retina readers, trackballs, trackpads, microphones, headsets, or the like.

Peripheral devices 1912 may be connected or communicate to I/O or other facilities, such as network interfaces, storage interfaces, or the like. Peripheral devices may be audio devices, cameras, dongles (e.g., for copy protection or ensuring secure transactions with a digital signature), external processors (e.g., for added functionality), microphones, monitors, network interfaces, printers, scanners, storage devices, video devices, video sources, goggles, visors, or the like.

It should be noted that although user input devices and peripheral devices may be employed, the ecosystem controller may be embodied as an embedded, dedicated, or monitor-less (i.e., headless) device, in which access would be provided over a network interface connection.

Cryptographic units such as microcontrollers, cryptographic processors 1926, cryptographic processor interfaces 1927, cryptographic devices 1928, or the like may be attached to or communicate with the ecosystem controller. For example, a MC68HC16 microcontroller, commonly manufactured by Motorola Inc., may be used for or within cryptographic units. (The MC68HC16 microcontroller utilizes a 16-bit multiply-and-accumulate instruction in the 16. MHz configuration and requires less than one second to perform a 512-bit RSA private key operation.) Equivalent microcontrollers or specialized processors may also be used, such as VLSI rechnology's 33 MHz 6868, Semaphore Communications' 40 MHz Roadrunner 184, or the like. Cryptographic units support the authentication of communications from interacting agents, as well as allowing for anonymous transactions. Cryptographic units may also be configured as part of the CPU 1903.

### Memory

A computer systemization generally requires and makes use of memory. The computer systemization 1902 includes memory 1929, which may be any device, mechanization, or medium allowing a processor to affect the storage or retrieval of information. Because memory is a fungible technology and resource, any number of memory units may be employed in lieu of or in concert with one another. It is to be understood that the ecosystem controller 1901 or the computer systemization 1902 may employ various forms of memory 1929. For example, the computer systemization 1902 may be configured so that the functionality of on-chip CPU memory (e.g., registers), RAM, ROM, and any other storage devices are provided by a paper-punch tape or paper-punch card mechanism; of course such an embodiment would result in a relatively slow rate of operation. In a typical configuration, memory 1929 will include ROM 1906, RAM 1905, and a storage device 1914. The storage device 1914 may be any conventional computer system storage, such as: a drum; a (fixed or removable) magnetic disk drive; a magneto-optical drive; an optical drive (e.g., CD-ROM/RAM/Recordable (R), ReWritable (RW), DVD RJRW); an array of devices (e.g., Redundant Array of Independent Disks (RAID)); or the like.

### Component Collection

The memory 1929 may contain a collection of program or database components or data such as: operating system component(s) 1915 (operating system); information server component(s) 1916 (information server); user interface component(s) 1917 (user interface); Web browser component(s) 1918 (Web browser); database(s) 1919; mail server component(s) 1921; mail client component(s) 1922; cryptographic server component(s) 1920 (cryptographic server); the ecosystem component(s) 1935; or the like. As a group, these components are referred to as a component collection. The components may be stored and accessed from the storage devices or from storage devices accessible through an interface bus. Although non-conventional program components such as those in the component collection are typically stored in a local storage device 1914, they may also be loaded or stored in memory such as: RAM, ROM, peripheral devices, remote storage facilities through a communications network, or the like.

### Operating System

The operating system component 1915 is an executable program component facilitating the operation of the ecosystem controller. Typically, the operating system facilitates access of I/O, network interfaces, peripheral devices, storage devices, or the like. The operating system may be a highly fault tolerant, scalable, and secure system such as: Apple Macintosh OS X (Server); AT&T Plan 9; Be OS; Unix and Unix and Unix-like system distributions (such as AT&T's UNIX; Berkley Software Distribution (BSD) variations such as FreeBSD, NetBSD, OpenBSD, or the like; Linux distributions such as Red Hat, Ubuntu, or the like); or like operating systems. More limited or less secure operating systems also may be employed, such as Apple Macintosh OS, IBM OS/2, Microsoft DOS, Microsoft Windows (e.g., Windows CE/NT/Vista/XP (Server)), Palm OS, or the like. An operating system may communicate to or with other components in a component collection, including itself, or the like. Frequently, the operating system communicates with other program components, user interfaces, or the like. For example, the operating system may contain, communicate, generate, obtain, or provide program component, system, user, or data communications, requests, or responses. The operating system, once executed by the CPU, may enable the interaction with communications networks, data, I/O, peripheral devices, program components, memory, user input devices, or the like. The operating system may provide communications protocols that allow the ecosystem controller to communicate with other entities through a communications network 1913. Various communication protocols may be used by the ecosystem controller as a subcarrier transport mechanism for interaction, such as, but not limited to: multicast, TCP/IP, UDP, unicast, or the like.

### Information Server

The information server component 1916 is a stored program component that is executed by a CPU. The information server may be a conventional Internet information server such as Apache Software Foundation's Apache, Microsoft's Internet Information Server, or the like. The information server may allow for the execution of program components through facilities such as Active Server Page (ASP), ActiveX, (ANSI) (Objective-) C (++), C# or .NET, Common Gateway Interface (CGI) scripts, Java, JavaScript, Practical Extraction Report Language (PERL), Hypertext Pre-Processor (PHP), pipes, Python, WebObjects, or the like. The information server may support secure communications protocols such as File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (e.g., Jabber or Open Mobile Alliance's (OMA's) Instant Messaging and Presence Service (IMPS)), Yahoo! Instant Messenger Service), or the like. The information server provides results in the form of Web pages to Web browsers, and allows for the manipulated generation of Web pages through interaction with other program components. After a Domain Name System (DNS) resolution portion of an HTTP request is resolved to a particular information server, the information server resolves requests for information at specified locations on the ecosystem controller based on the remainder of the HTTP request. For example, a request such as http://123.124.125.126/myInformation.html might have the IP portion of the request “123.124.125.126” resolved by a DNS server to an information server at that IP address; that information server might in turn further parse the HTTP request for the “/myInformation.html” portion of the request and resolve it to a location in memory containing the information “myInformation.html.” Additionally, other information serving protocols may be employed across various ports (e.g., FTP communications across port 21). An information server may communicate to or with other components in a component collection, including itself, or facilities of the like. Frequently, the information server communicates with the ecosystem database 1919, operating systems, other program components, user interfaces, Web browsers, or the like.

Access to the ecosystem database may be achieved through a number of database bridge mechanisms such as through scripting languages as enumerated below (e.g., CGI) and through inter-application communication channels as enumerated below (e.g., CORBA or WebObjects). Any data requests through a Web browser are parsed through the bridge mechanism into appropriate grammars as required by the ecosystem. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables or fields. In one embodiment, the parser may generate queries in standard SQL by instantiating a search string with the proper join/select commands based on the tagged text entries, in which the resulting command is provided over the bridge mechanism to the ecosystem as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

The information server component 1916 may also contain, communicate, generate, obtain, or provide program component, system, user, or data communications, requests, or responses.

### User Interface

Computer-interaction interfaces that employ elements such as icons, windows, strollers, menus, check boxes, and cursors (commonly referred to collectively as widgets) facilitate access to, and the operation and display of, data and computer hardware and operating system resources, functionality, and status. Such interfaces are commonly called user interfaces. Graphical user interfaces (GUIs)—such as the Apple Macintosh Operating System's OS X, IBM's OS/2, Microsoft's Windows (e.g., Windows CE/NT/Vista/XP (Server)), or Unix's X-Windows (which may include additional Unix graphic interface libraries and layers such as K Desktop Environment (KDE), mythTV, or GNU Network Object Model Environment (GNOME))—provide a baseline and means of accessing and displaying information graphically to users.

A user interface component 1917 is a stored program component that is executed by a CPU. The user interface may be a conventional graphical user interface as provided by, with, or atop operating systems or operating environments such as already discussed. The user interface may allow for the display, execution, interaction, manipulation, or operation of program components or system facilities through textual or graphical facilities. The user interface provides a facility through which users may affect, interact, or operate a computer system. A user interface may communicate to or with other components in a component collection, including itself, or facilities of the like. Frequently, the user interface communicates with operating systems, other program components, or the like. The user interface may contain, communicate, generate, obtain, or provide program component, system, user, or data communications, requests, or responses.

### Web Browser

A Web browser component 1918 is a stored program component that is executed by a CPU. The Web browser may be a conventional hypertext viewing application such as Microsoft Internet Explorer, Netscape Navigator, or the like. Secure Web browsing may be supplied with 128-bit (or greater) encryption by way of HTTPS, SSL, or the like. Some Web browsers allow for the execution of program components through facilities such as Java, JavaScript, ActiveX, Web-browser plug-in APIs (e.g., FireFox, Safari Plug-in), or the like. Web browsers and like information access tools may be integrated into PDAs, cellular telephones, or other mobile devices. A Web browser may communicate to or with other components in a component collection, including itself, or like facilities. Frequently, the Web browser communicates with information servers, operating systems, integrated program components (e.g., plug-ins), or the like. The Web browser may contain, communicate, generate, obtain, or provide program component, system, user, or data communications, requests, or responses. Of course, in place of a Web browser and information server, a combined application may be developed to perform similar functions of both. The combined application would similarly affect obtaining and providing information to users, user agents, or the like from the ecosystem-enabled controllers. The combined application may be unnecessary on systems employing standard Web browsers.

### Mail Server

A mail server component 1921 is a stored program component that is executed by the CPU 1903. The mail server may be a conventional Internet mail server such as sendmail, Microsoft Exchange, or the like. The mail server may allow for the execution of program components through facilities such as ASP, ActiveX, (ANSI) (Objective-) C (++), C# or .NET, CGI scripts, Java, JavaScript, PERL, PHP, pipes, Python, WebObjects, or the like. The mail server may support communications protocols such as: Internet message access protocol (IMAP), Messaging Application Programming Interface (MAPI)/Microsoft Exchange, post office protocol (POP3), simple mail transfer protocol (SMTP), or the like. The mail server can route, forward, and process incoming and outgoing mail messages that have been sent, relayed, or otherwise travel through or to the ecosystem.

Access to the ecosystem mail may be achieved through a number of APIs offered by the individual Web server components or the operating system.

Also, a mail server may contain, communicate, generate, obtain, or provide program component, system, user, or data communications, requests, information, or responses.

### Mail Client

A mail client component 1922 is a stored program component that is executed by the CPU 1903. The mail client may be a conventional mail viewing application such as Apple Mail, Microsoft Entourage, Microsoft Outlook, Microsoft Outlook Express, Mozilla, Thunderbird, or the like. Mail clients may support a number of transfer protocols, such as: IMAP, Microsoft Exchange, POP3, SMTP, or the like. A mail client may communicate to or with other components in a component collection, including itself, or like facilities. Frequently, the mail client communicates with mail servers, operating systems, other mail clients, or the like; e.g., it may contain, communicate, generate, obtain, or provide program component, system, user, or data communications, requests, information, or responses. Generally, the mail client provides a facility to compose and transmit electronic mail messages.

### Cryptographic Server

A cryptographic server component 1920 is a stored program component that is executed by the CPU 1903, cryptographic processor 1926, cryptographic processor interface 1927, cryptographic processor device 1928, or the like. Cryptographic processor interfaces allow expedited encryption or decryption requests by the cryptographic server component 1920, which alternatively may run on a conventional CPU. The cryptographic server component 1920 allows for the encryption or decryption of provided data. The cryptographic server component 1920 allows for both symmetric and asymmetric encryption or decryption (e.g., Pretty Good Protection (PGP)), and may employ cryptographic techniques such as: digital certificates (e.g., X.509 authentication framework), digital signatures, dual signatures, enveloping, password access protection, public key management, or the like. The cryptographic server component will facilitate numerous (encryption or decryption) security protocols such as: passwords, checksum, Data Encryption Standard (DES), Elliptical Curve Encryption (ECC), International Data Encryption Algorithm (IDEA), Message Digest 5 (MD5), Rivest Cipher 5 (RC5), Rijndael, RSA, Secure Hash Algorithm (SHA), Secure Socket Layer (SSL), Secure Hypertext Transfer Protocol (HTTPS), or the like. Employing such encryption security protocols, the ecosystem may encrypt all incoming or outgoing communications and may serve as a node within a virtual private network (VPN) with a wider communications network. The cryptographic server component 1920 facilitates the process of “security authorization,” in which access to a resource is inhibited by a security protocol such that the cryptographic server component effects authorized access to the secured resource. In addition, the cryptographic server component may provide unique identifiers of content (e.g., employing an MD5 hash to obtain a unique signature for a digital audio file). The cryptographic server component may communicate to or with other components in a component collection, including itself, or like facilities. The cryptographic server component supports encryption schemes allowing for the secure transmission of information across a communications network to enable the ecosystem component to engage in secure transactions if so desired. The cryptographic server component facilitates the secure accessing of resources on the ecosystem and facilitates the access of secured resources on remote systems; i.e., it may act as a client or server of secured resources. Frequently, the cryptographic server component communicates with information servers, operating systems, other program components, or the like. The cryptographic server component may contain, communicate, generate, obtain, or provide program component, system, user, or data communications, requests, or responses.

### Ecosystem Database

The ecosystem database component 1919 may be embodied in a database and its stored data. The database is a stored program component, which is executed by the CPU; the stored program component portion configures the CPU to process the stored data. The database may be a conventional, fault tolerant, relational, scalable, secure database (e.g., Oracle or Sybase). Relational databases are an extension of a flat file and consist of a series of related tables. The tables are interconnected via a key field. Using the key field allows combining the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the ecosystem database may be implemented using various standard data-structures, such as an array, hash, (linked) list, struct, structured text file (e.g., XML), table, or the like. Such data structures may be stored in memory or in (structured) files. In another alternative, an object-oriented database may be used, such as Frontier, ObjectStore, Poet, Zope, or the like. Object-oriented databases can include a number of object collections that are grouped or linked together by common attributes; they may be related to other object collections by some common attributes. Object-oriented databases perform similarly to relational databases with the exception that objects are not just pieces of data but may have other types of functionality encapsulated within a given object. If the ecosystem database is implemented as a data structure, the use of the ecosystem database 1919 may be integrated into another component such as the ecosystem component 1935. Also, the database may be implemented as a mix of data structures, objects, and relational structures. Databases may be consolidated or distributed in countless variations through standard data-processing techniques. Portions of databases (e.g., tables) may be exported or imported and thus decentralized or integrated.

In one embodiment, the database component 1919 includes several tables 1919a-g. A client table 1919a includes fields such as: a client_account_ID, client_subaccount_ID, investor_number, name, address, telephone_number, e-mail, identifier, financial_data, incorporation_data, investor_levelstatus (e.g., sophisticated or risk averse), Company_Registration_Number, transaction_ID, QIB_agreement_terms, QIB_qualification_status, or the like. The client table may support or track multiple entity accounts on a ecosystem. An investment table 1919b includes fields such as: investment_ID, QIB_ID, broker_ID, investor_number, client_account_ID, client_subaccount_ID, issuer_ID, maximum_number_of_investors, total_capital_requirement, minimum_investment_amount, minimum_number_sharesper_trade, minimum_holding_size, minimum_number_slots_per_investor, maximum_number_slots_per_investor, time_limit_to_transact, legal_documentation_records, bid_price, ask_price, investor_list_size, investment_slots_available, or the like. An issuer table 1919c includes fields such as: issuer_ID, issuer name, investment_address, investor_number, client_account_ID, client_subaccount_ID, issuer_ID, QIB terms, or the like. An broker table 1919d includes fields such as: broker_ID, issuer_ID, name, address, client_account_ID, client_subaccount_ID, issuer_ID, or the like. A custodian table 1919a includes fields such as, but not limited to: a custodian_ID, client_account_ID, client_subaccount_ID, investor_number, name, address, identifier, or the like. A transaction table 1919f includes fields such as, but not limited to: a transaction_ID, client_ID, custodian_ID, client_account_ID, client_subaccount_ID, broker_ID, investment_ID, price, instrument_ID, contract_ID, or the like. A contract table 1919g includes fields such as, but not limited to: a contract_ID, transaction_ID, client_ID, custodian_ID, client_account_ID, client_subaccount_ID, broker_ID, investment_ID, price, instrument_ID, contract_type, contract_data, QIB_terms, or the like.

In one embodiment, the ecosystem database may interact with other database systems. For example, employing a distributed database system and queries and data access by the ecosystem component 1935, one may treat the combination of the ecosystem database and an integrated data security layer database as a single database entity.

In one embodiment, user programs may contain various user interface primitives, which may serve to update the ecosystem. Also, various accounts may require custom database tables depending upon the environments and the types of clients the ecosystem may need to serve. It should be noted that any unique fields may be designated as a key field throughout. In an alternative embodiment, these tables have been decentralized into their own databases and their respective database controllers (i.e., individual database controllers for each of the above tables). Employing standard data-processing techniques, one may further distribute the databases over several computer systemizations or storage devices. Similarly, configurations of the decentralized database controllers may be varied by consolidating or distributing the various database components 1919a-g. The ecosystem may be configured to keep track of various settings, inputs, and parameters via database controllers.

The ecosystem database nay communicate to or with other components in a component collection, including itself, or like facilities. Frequently, the ecosystem database communicates with the ecosystem component, other program components, or the like. The database may contain, retain, and provide information regarding other nodes and data.

### Ecosystem Component

The ecosystem component 1935 is a stored program component that is executed by the CPU 1903. In various embodiments, the ecosystem component incorporates any or all combinations of the aspects of the ecosystem that are depicted in the previous figures and discussed above. As such, the ecosystem component 1935 affects accessing, obtaining, and providing information, services, transactions, or the like across various communications networks.

In one embodiment, the ecosystem component 1935 enables investors to maximize liquidity while minimizing regulatory obligations, creating a market place that otherwise would not exist.

The ecosystem component 1935 may enable access of information between nodes by employing standard development tools and languages such as: Apache components, Assembly, ActiveX, binary executables, (ANSI) (Objective-) C (++), C# or .NET, database adapters, CGI scripts, Java, JavaScript, mapping tools, procedural and object oriented development tools, PERL, PHP, Python, shell scripts, SQL commands, web application server extensions, WebObjects, or the like. In one embodiment, the ecosystem component employs a cryptographic server to encrypt and decrypt communications. The ecosystem component may communicate to or with other components in a component collection, including itself, or like facilities. Frequently, the ecosystem component communicates with the ecosystem database, operating systems, other program components, or the like. The ecosystem may contain, communicate, generate, obtain, or provide program component, system, user, or data communications, requests, or responses.

### Distributed Ecosystems

The structure or operation of any components of the ecosystem controller 1935 may be combined, consolidated, or distributed in any number of ways to facilitate development or deployment. Similarly, the component collection may be combined in any number of ways to facilitate deployment or development. In some embodiments, the components are integrated into a common code base or in a facility that can dynamically load the components on demand in an integrated fashion.

The component collection may be consolidated or distributed in countless variations through standard data processing or development techniques. Multiple instances of any one of the program components in the program component collection may be instantiated on a single node, or across numerous nodes to improve performance through load-balancing or data-processing techniques. Furthermore, single instances may also be distributed across multiple controllers or storage devices (e.g., databases). All program component instances and controllers working in concert may do so through standard data-processing communication techniques.

The configuration of the ecosystem controller will typically depend on the context of system deployment. Factors such as the budget, capacity, location, or use of the underlying hardware resources may affect deployment requirements and configuration. Regardless of whether the configuration results in more consolidated or integrated program components, results in a more distributed series of program components, or results in some combination between a consolidated and distributed configuration, data may be communicated, obtained, or provided. Instances of components consolidated into a common code base from the program component collection may communicate, obtain, or provide data. This may be accomplished through intra-application data-processing communication techniques such as: data referencing (e.g., pointers), internal messaging, object instance variable communication, shared memory space, variable passing, or the like.

If component collection components are discrete, separate, or external to one another, then communicating, obtaining, or providing data with or to other components may be accomplished through inter-application data-processing communication techniques such as: Application Program Interfaces (API) information passage; (distributed) Component Object Model ((D)COM), (Distributed) Object Linking and Embedding ((D)OLE), or the like), Common Object Request Broker Architecture (CORBA), local and remote application program interfaces (e.g., Jini), Remote Method Invocation (RMI), process pipes, shared files, or the like. Messages sent between discrete component components for inter-application communication or within memory spaces of a singular component for intra-application communication may be facilitated through the creation and parsing of a grammar. A grammar may be developed by using standard development tools such as lex, yacc, XML, or the like, which allow for grammar-generation and parsing functionality, which in turn may form the basis of communication messages within and between components. Again, the configuration will typically depend upon the context of system deployment.

### Other Exemplary Uses of the Ecosystem

The invention may be used in connection with merger-and-acquisition transactions, including transactions involving securities as consideration or as financing. For example, the invention may be used in connection with financing a leveraged buyout through an offering to QIBs, or for public-to-private transactions.

The invention may also be used for transactions involving United States-based issuers as well as non-United States-based issuers of securities.

The invention may also be used for transactions in securities, including equities, notes, bonds, and options, as well as other financial instruments and other commitments that may or may not be securities, including bank loans, swaps, forward contracts, contingent instruments, and risk-management products.

The invention may also be used in connection with educating QIBs or custodians as to the specific market/issuer features needed for informed securities acquisition.

An ecosystem according to the invention may also be used to create a trading environment in which different levels or classes of securities are formed. As such, differing voting/non-voting classes may be established through the ecosystem. Securities, contracts, commodities, and other instruments may be handled by the ecosystem, including voting or non-voting common or preferred stock, fixed-income bonds, corporate bonds, mortgage-backed bonds, asset-backed bonds, debentures, bank loans, trade claims, contingent instruments, and physical commodities. The ecosystem may also retain historical sales and pricing information and allow participants, including the issuer and the transfer agent, to review such information.

An ecosystem according to the invention may also be used to perform ERISA monitoring, as well as various reporting functions. The ecosystem may also provide waiting-list notifications to inventors or designated liquidity providers. Financing of transactions (arranged financing) may also be accomplished through the ecosystem.

The invention may also provide an ecosystem in which the broker can underwrite securities being issued by an issuer and can establish a market for the securities based upon the needs of the market. Thus, a broker may underwrite the placement of securities, allowing the issuer to invest further the monies received from the sale of the securities, such as for merger or acquisition purposes.

In another embodiment of the invention, the number of designated liquidity providers may be chosen, such that a maximum or minimum number of designated liquidity providers is established for the overall market. In one embodiment of the invention, one designated liquidity provider is present for all trades for bid/ask orders. As provided by the ecosystem, the designated liquidity providers may sell short within ecosystem. The designated liquidity providers may be banks.

In another embodiment of the invention, a medium storing instructions adapted to be executed by a processor is provided. The instructions include:
identifying at least one eligibility prerequisite that governs whether an entity is eligible to participate in the ecosystem;
determining whether the entity meets the at least one eligibility prerequisite, thereby being eligible to participate in the ecosystem;
identifying at least one ecosystem rule that governs whether an entity is qualified to participate in the ecosystem;
determining whether the entity is willing to agree to the at least one ecosystem rule, thereby being qualified to participate in the ecosystem;
when the entity is eligible and qualified, processing data regarding executing a contract in which the entity agrees to adhere to the at least one ecosystem rule, thereby allowing the entity to participate in the ecosystem; and
processing data regarding entering into at least one designated ecosystem transaction by the entity.

Numerous other embodiments will be readily apparent to those skilled in the art. The entirety of this disclosure (including the Cover Page, Title, Headings, Field of the Invention, Background of the Invention, Summary of the Invention, Brief Description of the Drawings, Detailed Description of Preferred Embodiments, Claims, Abstract, Figures, and otherwise) shows by way of illustration various embodiments in which the claimed inventions may be practiced. In fact, the numerous embodiments of the ecosystem may constitute numerous inventions, and reference to the “invention” was provided for the sake of simplicity and should not be viewed as a suggestion that disclosure provides description of a singular invention. The features and advantages described in the disclosure are of a representative sample of embodiments only, and are not exhaustive or exclusive. They are presented only to assist in understanding and teach the invention. It should be understood that they are not representative of all inventions we could claim.

In view of this, certain aspects of the invention have not been discussed in this disclosure. That alternate embodiments may not have been presented for a specific aspect of the invention, or that further undescribed alternate embodiments may be available for an aspect, is not to be considered a disclaimer of those alternate embodiments. It will be appreciated that many of those undescribed embodiments incorporate the same aspects of the invention that are described, and others are equivalent. Thus, it is to be understood that other embodiments may be utilized, and that functional, logical, organizational, structural, or topological modifications may be made without departing from the scope or spirit of the invention.

All examples or embodiments throughout this disclosure are intended to be non-limiting. As used in this disclosure, “including” indicates that the matter following is illustrative, not exclusive. Also, the only inference that should be drawn regarding those embodiments discussed relative to those not discussed is that embodiments were not discussed for purposes of reducing space and repetition. For instance, it is to be understood that the logical or topological structure of any combination of any program components (a component collection), other components, or any present feature sets as described in the figures or throughout are not limited to a fixed operating order or arrangement, but rather, any disclosed order is exemplary and all equivalents, regardless of order, are contemplated by the disclosure. Furthermore, it is to be understood that such features are not limited to serial execution; the disclosure contemplates that any number of threads, processes, services, servers, or the like may execute asynchronously, synchronously, concurrently, simultaneously, in parallel, or the like. As such, some of these features may be mutually contradictory, in that they cannot simultaneously be present in a single embodiment. Similarly, some features are applicable to one or more aspects of the invention and inapplicable to others.

In addition, this disclosure may include other inventions not currently claimed. Applicant reserves all rights in any such currently unclaimed inventions, including the right to claim such inventions or file additional applications, continuations, continuations-in-part, or divisions. As such, it should be understood that advantages, embodiments, examples, functions, or features, or logical, organizational, structural, topological, or other aspects of the disclosure, are not to be considered limitations on the disclosure as defined by the claims or limitations on equivalents to the claims.

What is claimed is:

1. An apparatus, comprising:
(a) a processor;
(b) a storage device in communication with the processor;
(c) means for determining whether an entity meets at least one eligibility prerequisite for an ecosystem, thereby being eligible to participate in the ecosystem;
(d) means for determining whether an entity is willing to agree to at least one ecosystem rule, thereby being qualified to participate in the ecosystem;
(e) means for processing data regarding executing a contract in which the entity agrees to adhere to the at least one ecosystem rule, thereby allowing the entity to participate in the ecosystem; and
(f) means for processing data regarding entering into at least one designated ecosystem transaction by the entity.

2. The apparatus of claim 1, further comprising:
(g) means for determining whether the entity agrees to adhere to at least one designation prerequisite and is within a limitation criterion; and
(h) means for processing data regarding granting the entity designated status, thereby permitting the entity to engage in the at least one designated ecosystem transaction.

3. The apparatus of claim 2, wherein the at least one designation prerequisite comprises one or more issuer-specific criteria and the limitation criterion is a number of holders of record.

4. The apparatus of claim 3, wherein the number of holders of record is less than 500.

5. An apparatus, comprising:
(a) a processor;
(b) a storage device in communication with the processor and storing instructions adapted to be executed by the processor to:
(i) identify at least one eligibility prerequisite that governs whether an entity is eligible to participate in an ecosystem;
(ii) determine whether the entity meets the at least one eligibility prerequisite, thereby being eligible to participate in the ecosystem;
(iii) identify at least one ecosystem rule that governs whether an entity is qualified to participate in the ecosystem;
(iv) determine whether the entity is willing to agree to the at least one ecosystem rule, thereby being qualified to participate in the ecosystem;
(v) when the entity is eligible and qualified, process data regarding executing a contract in which the entity agrees to adhere to the at least one ecosystem rule, thereby allowing the entity to participate in the ecosystem; and
(vi) process data regarding entering into at least one designated ecosystem transaction by the entity.

6. A computer-implemented method for establishing and operating an ecosystem, comprising:
(a) identifying at least one eligibility prerequisite that governs whether an entity is eligible to participate in the ecosystem;
(b) determining whether the entity meets the at least one eligibility prerequisite, thereby being eligible to participate in the ecosystem;
(c) identifying at least one ecosystem rule that governs whether an entity is qualified to participate in the ecosystem;
(d) determining whether the entity is willing to agree to the at least one ecosystem rule, thereby being qualified to participate in the ecosystem;
(e) when the entity is eligible and qualified, executing a contract in which the entity agrees to adhere to the at least one ecosystem rule, thereby allowing the entity to participate in the ecosystem; and
(f) entering into at least one designated ecosystem transaction by the entity.

7. The method of claim 6, wherein the at least one eligibility prerequisite comprises Qualified Institutional Buyer status for entities transacting in securities.

8. The method of claim 6, wherein the at least one ecosystem rule comprises prohibiting short selling.

9. The method of claim 6, further comprising:
(g) identifying at least one designation prerequisite and a limitation criterion that govern whether the entity is permitted to engage in the at least one designated ecosystem transaction;
(h) determining whether the entity meets the at least one designation prerequisite and the limitation criterion, thereby being permitted to engage in the at least one designated ecosystem transaction; and
(i) when the entity is so permitted, granting the entity designated status, thereby allowing the entity to engage in the at least one designated ecosystem transaction.

10. The method of claim 9, wherein the at least one designation prerequisite comprises one or more issuer-specific criteria and the limitation criterion is a number of holders of record.

11. The method of claim 10, wherein the number of holders of record is less than 500.

12. A computer-implemented method for establishing and operating an ecosystem, comprising:
(a) identifying at least one first prerequisite that governs whether an entity is eligible to participate in the ecosystem;
(b) determining whether the entity meets the at least one first prerequisite, thereby being eligible to participate in the ecosystem;
(c) identifying at least one second prerequisite that governs whether an entity is qualified to participate in the ecosystem;
(d) determining whether the entity meets the at least one second prerequisite, thereby being qualified to participate in the ecosystem;
(e) when the entity is eligible and qualified, executing a contract in which the entity agrees to adhere to the at least one second prerequisite, thereby allowing the entity to participate in the ecosystem;
(f) identifying at least one third prerequisite that governs whether the entity is permitted to engage in one or more designated ecosystem transactions;
(g) determining whether the entity meets the at least one third prerequisite, thereby permitting the entity to engage in designated ecosystem transactions;
(h) when the entity is so permitted, granting the entity designated status, thereby allowing the entity to engage in designated ecosystem transactions; and
(i) entering into one or more designated ecosystem transactions by the entity.

13. The method of claim 12, wherein the at least one first prerequisite comprises an investor status.

14. The method of claim 13, wherein the investor status is Qualified Institutional Buyer.

15. The method of claim 12, wherein the at least one second prerequisite comprises at least one ecosystem rule.

16. The method of claim 15, wherein the at least one ecosystem rule comprises prohibiting short selling.

17. The method of claim 12, wherein the at least one third prerequisite comprises at least one issuer-specific criterion.

18. The method of claim 17, wherein the one or more issuer-specific criteria comprises prohibiting short selling.

19. The method of claim 17, wherein the at least one third prerequisite further comprises one or more limitation criteria.

20. The method of claim 19, wherein the one or more limitation criteria comprises a number of holders of record.

21. The method of claim 20, wherein the number of holders of record is less than 500.

22. A computer-implemented method for establishing and operating an ecosystem, comprising:
(a) processing data regarding determining whether an entity meets at least one eligibility prerequisite, thereby being eligible to participate in the ecosystem;
(b) processing data regarding determining whether an entity is willing to agree to at least one ecosystem, thereby being qualified to participate in the ecosystem;
(c) when the entity is eligible and qualified, processing data regarding executing a contract in which the entity agrees to adhere to the at least one ecosystem rule, thereby allowing the entity to participate in the ecosystem; and
(d) processing data regarding entering into at least one designated ecosystem transaction by the entity.

23. The computer-based method of claim 22, wherein the at least one eligibility prerequisite comprises Qualified Institutional Buyer status.

24. The method of claim 22, further comprising:
(e) processing data regarding determining whether the entity agrees to adhere to at least one designation prerequisite and is within a limitation criterion, thereby permitting the entity to engage in at least one designated ecosystem transaction; and
(f) when the entity is so permitted, processing data regarding granting the entity designated status, thereby allowing the entity to engage in the at least one designated ecosystem transaction.

25. The method of claim 24, wherein the at least one designation prerequisite comprises one or more issuer-specific criteria and the limitation criterion is a number of holders of record.
